(19) United States
(12) Patent Application Publication
(10) Pub. No.: US 2021/0323750 A1
(43) Pub. Date: Oct. 21, 2021

(54) SYSTEM AND METHOD FOR EXTENDING THE SHELF LIFE OF A PACKAGE CONTAINING A FRESH FOOD PRODUCT

(71) Applicant: Cryovac, LLC, Charlotte, NC (US)

(72) Inventors: Henry Walker Stockley, Lake Wylie, SC (US); Barbara Giusti, Usmate Velate (MB) (IT)

(21) Appl. No.: 17/264,995

(22) PCT Filed: Jul. 31, 2019
(86) PCT No.: PCT/US2019/044279

§ 371 Date: Feb. 1, 2021

Related U.S. Application Data
(60) Provisional application No. 62/863,556, filed on Jun. 19, 2019.
(60) Provisional application No. 62/714,331, filed on Aug. 3, 2018.

(51) Int. Cl. B65D 81/26; B65B 25/06; B65B 31/02; B65B 51/22; B65D 77/04; B65B 11/52; B65D 65/40; B32B 1/00; B32B 27/32; B32B 27/08; B32B 27/20; B32B 27/30; B32B 7/12

(52) U.S. Cl. CPC B65D 81/268; B32B 2307/736; B65B 31/024; B65B 51/225; B65B 25/067; B65D 77/04; B65B 11/52; B65D 65/40; B32B 1/00; B32B 27/32; B32B 27/08; B32B 27/20; B32B 27/306; B32B 27/304; B32B 7/12; B65B 2220/16; B65D 2565/387; B65D 2565/388; B65D 2577/043; B32B 2307/724; B32B 2439/70; B32B 2270/00; B32B 2264/1021; B32B 2250/05; B32B 2250/24; B32B 2250/03; B32B 2307/31; B32B 2307/7244; B65B 25/062

(57) ABSTRACT

A package, system and method for packaging a fresh food product having an improved shelf-life. The system includes: one or more individual packages having a food product sealed therein, the packages are made from an oxygen permeable film having an oxygen transmission rate (OTR) of at least 10,000 cc (STP)/m²/day/1 atm at 23° C. at 0% relative humidity (RH) measured according to ASTM 3985. The individual packages are disposed in an interior space of a master pouch. The master pouch is made from a film having an oxygen barrier layer such that the OTR of the master pouch film is less than 20 cc (STP)/m²/day/1 atm at 23° C. at 0% RH measured according to ASTM 3985. The interior space of the master pouch includes a modified atmosphere having CO₂ and has an oxygen concentration that is less than 0.1% by volume.

### FIELD

The invention relates generally to a system and method for packaging a perishable fresh food product, and more particularly to a system and method in which a plurality of individual food products are packaged in an oxygen permeable package, that are then collectively packaged in a master pouch having a modified atmosphere that is predominately carbon dioxide

### BACKGROUND

In many cases, the process of getting a fresh food product from a point of origin to the final retail location where it is displayed for purchase is a multi-step process. Generally, the process includes harvesting, processing, and packaging the food product. In addition, the packaged food product may be processed through a distribution network where it is first transported to a distribution center prior to reaching the final retail location, such as a grocery store. In order for the packaged food product to be acceptable to the consumer it must maintain its “freshness” for a sufficient amount of time to be displayed and purchased by the consumer. For food products sourced locally or within a relatively close geographic location to the distribution network, maintaining freshness is generally not a concern.

Increasingly though, many fresh food products, such as fish and other meats, are harvested, processed, packaged, and shipped from locations that are geographically remote from where they are ultimately displayed and sold to retail consumers. For economic reasons, it may be desirable to transport the packaged food products by ocean freight liners. However, shipping by such freight liners may take an extended length of time, during which, the packaged food products may undesirably have a change in appearance and an increased likelihood of spoilage. In addition, long distance transport of the packaged food products by ocean freight liners may also reduce the available shelf-life of the packaged food product when it reaches its final retail destination. As a result, the packaged food product may not have the desirable freshness that the consumer demands and expects.

One potential solution to spoilage and potential loss of freshness is to freeze the packaged food product during transport. Unfortunately, freezing is not an acceptable solution for all food products. For example, in the case of fish, freezing may cause undesirable changes in the appearance and texture of the tissue, which may result in the packaged food product being unacceptable to the consumer.

Thus, a need still exists to provide a system and method for packaging fresh food products that helps provide an extended shelf-life of the product for transport, distribution, and retail display.

### SUMMARY

The invention is directed to a method and system for packaging a fresh food product, such as a fish product, that may advantageously help extend the total shelf-life of the packaged food product.

In the packaging of some food products, such as fish, extension of shelf-life has generally been limited by the desire to use oxygen permeable films having a high oxygen transmission rate to help prevent the growth of anaerobic bacteria, such as Clostridium botulinum. The requirement of oxygen permeable films has generally limited the shelf-life of such packaged food products. Embodiments of the present invention may help extend the total shelf-life of packaged food products, such as fish, by enclosing the individual packages with a high oxygen permeable film in a master pouch having a modified atmosphere that includes carbon dioxide, and has an oxygen concentration that is less than 0.1% by volume.

More particularly, the food product is vacuum packaged in a bag or with a film having an oxygen transmission rate (OTR) of at least 10,000 cc (STP)/m²/day/1 atm at 23° C. and 0% relative humidity (RH). A plurality of these individual packages are introduced into an opening of a master pouch having barrier properties. Prior to sealing of the opening of the master pouch, the interior space of the master pouch is flushed with a modified atmosphere that is predominately comprised of CO₂. Desirably, the modified atmosphere in the interior space of the master pouch has a residual oxygen concentration (residual oxygen refers to any oxygen remaining in the master pouch following introduction of the modified atmosphere) that is less than 0.1%, and in particular, less than 0.01% by volume. The residual oxygen content of less than 0.1% or less may be obtained by repeated evacuation and flushing of the modified atmosphere within the master pouch and/or the use of oxygen scavenging compositions in the interior space of the master pouch. The oxygen scavenging composition may be provided in the form of a sachet that is placed into the interior space or may be present as an oxygen scavenging layer in a film that is used to prepare the master pouch.

It has been found that the combination of a modified atmosphere that predominately comprises CO₂ with a residual oxygen concentration that is less than 0.1% helps to inhibit the growth of bacteria during cold storage (e.g., −1.5 to 0.5° C.) while also helping the product maintain a desirable appearance (e.g., color) and odor after the individual packages are removed from the master pouch and presented for retail display.

As a result, aspects of the invention may help provide a system and method that allows for the processing, packaging, and transport of fresh food products from geographically remote locations while minimizing bacterial growth and maintaining desirable color and odor of the food product. Advantageously, the cold storage and transport of the packaged food product may be accomplished without freezing the food product.

In one aspect, the invention is directed to a system for packaging a fresh food product having an improved shelf-life, the system comprising: one or more individual packages having a food product sealed therein, the packages comprising an oxygen permeable film having an oxygen transmission rate (OTR) of at least 10,000 cc (STP)/m²/day/1 atm at 23° C. and 0% relative humidity (RH); a master pouch having an interior space in which the plurality of packages are enclosed, the master pouch comprising a multilayer film having an oxygen barrier layer such that the OTR of the master pouch is less than 20 cc (STP)/m²/day/1 atm at 23° C. and 0% RH; and a modified atmosphere in the interior space of the master pouch having an oxygen concentration that is less than 0.1%.

The system and associated method may be used to package and transport a wide variety of food products including fruits, vegetables, and various meat products, such as pork, cow, and fish based meat products. In one particular embodiment, the food product comprises fish, such as tilapia, salmon, and tuna fillets.

In some embodiments, an oxygen scavenging composition is in fluid communication with the modified atmosphere of the master pouch. For example, the oxygen scavenging composition may be disposed in a sachet within the interior space of the master pouch.

In certain embodiments, the t oxygen scavenging composition comprises a layer of the multilayer film from which the master pouch is formed.

In some embodiments, the modified atmosphere is selected from nitrogen gas, carbon dioxide gas, and mixtures thereof. In embodiments, the modified atmosphere is primarily comprised of carbon dioxide.

In some embodiments, a time temperature indicator (TTI) is disposed in the interior space of the master pouch. In other embodiments, a TTI may be affixed to an exterior surface of the master pouch.

In one embodiment, the oxygen permeable film of the one or more individual packages has an OTR of at least 20,000 cc (STP)/m²/day/1 atm at 23° C. at 0% RH.

In some embodiments, the individual packages disposed in the master pouch have been packaged in a vacuum shrink bag. In still other embodiments, the one or more individual packages have been thermoformed vacuum skin packaged.

In some embodiments, the fresh food product is stored at a temperature of between −1.5 and 1° C., and has a shelf-life from the initial day of packaging of at least 28 days prior to any retail display. In certain embodiments, the packaged fresh food product has a total shelf-life of 28 to 35 days.

A further aspect of the invention is directed to a method of packaging a fresh food product comprising the steps of: sealing a fresh food product within a package, the package comprising an oxygen permeable film having an OTR of at least 10,000 cc (STP)/m²/day/1 atm at 23° C. at 0% relative humidity RH; introducing one or more sealed packages within a master pouch, the master pouch comprising a multilayer film having an oxygen barrier layer such that the OTR of the master pouch is less than 20 cc (STP)/m²/day/1 atm at 23° C. at 0% RH; introducing a modified atmosphere into the interior space of the master pouch; sealing the master pouch to enclose the plurality of the sealed packages therein; and reducing residual oxygen concentration in the interior space of the master pouch to about 0.1% or less within 24 hours of sealing the master pouch.

In one embodiment, the step of reducing the residual oxygen concentration in the master pouch includes the step of introducing an oxygen absorber sachet into the interior space of the master pouch prior to the step of sealing the master pouch.

In a further embodiment, the method includes a step of introducing a TTI into the interior space or on the exterior of the master pouch prior to the step of sealing the master pouch.

In one embodiment, the modified atmosphere of the master pouch comprises carbon dioxide.

In certain embodiments, the step of sealing a fresh food product within a package comprises vacuum shrink packaging the fresh food product. In some embodiments, the step of sealing a fresh food product within a package comprises packaging the fresh food product in a vacuum shrink bag.

In some embodiments, the step of sealing a fresh food product within a package comprises a thermoforming vacuum skin packaging step in which the oxygen permeable film is sealed to a support member.

In a further aspect, the method includes a step of transporting the sealed master pouch at a temperature that is from about −0.5 to −1.5° C.

In certain embodiments, the method further comprises removing the food packages from the master pouch, and then displaying the food packages in a retail display at a temperature that is from about 1 to 4° C. In some embodiments, the fresh food product has a total shelf-life of 20 to 35 days.

In an embodiment, a packaged fresh food product is disclosed. The packaged fresh food product includes a plurality of packages having a fresh food product sealed therein, the packages comprising an oxygen permeable film, the oxygen permeable film having an oxygen transmission rate (OTR) of at least 10,000 cc (STP)/m²/day/1 atm at 23° C. and 0% relative humidity (RH) as measured in accordance with ASTM D3985; a master pouch having an interior space in which the plurality of packages are enclosed, the master pouch comprised of a film having an oxygen barrier layer such that the OTR of the film of the master pouch is less than 20 cc (STP)/m²/day/1 atm at 23° C. and 0% RH as measured in accordance with ASTM D3985; and a modified atmosphere in the interior space of the master pouch comprising carbon dioxide and having an oxygen concentration that is less than 0.1% by volume.

In embodiments, the packaged fresh food product includes embodiments and aspects identified with the systems and methods described herein.

### BRIEF DESCRIPTION OF THE DRAWINGS

Having thus described the invention in general terms, reference will now be made to the accompanying drawings, which are not necessarily drawn to scale, and wherein:

FIG. 1 shows a system for packaging food products in accordance with at least on embodiment;

FIG. 2 is a cross-section of a multilayer, oxygen barrier film for use in preparing the master pouch;

FIG. 3 is a cross-section of a multilayer, oxygen permeable film that may be used to prepare individual packages comprising a food product enclosed therein; and

FIG. 4 is a graph showing the subjective color appearance of packaged fillets as a function of residual oxygen concentration in a modified atmosphere package.

### DETAILED DESCRIPTION

As used in the specification, and in the appended claims, the singular forms “a,” “an,” “the,” include plural referents unless the context clearly dictates otherwise.

### I. Definitions

For the purposes of the present application, the following terms shall have the following meanings:

The terms “about” and “substantially” as used herein means a deviation (plus/minus) of less than 10%, and in particular, less than 5%, less than 4%, less than 3%, and less than 2% of the recited value.

The term “shelf-life” of a perishable article, such as a food product, refers to the length of time that a product can be stored or displayed before it deteriorates sufficiently to be hazardous to health (e.g., if consumed) or commercially unacceptable for sale. An item may be considered expired after its shelf-life has been depleted. In some embodiments, the shelf-life may be calculated in days. Shelf-life may be dependent upon the nature of the item itself, the age of the item, the environmental conditions to which it has been exposed, and the duration of any such exposure.

The term “fresh food product” refers to a non-frozen food product that is perishable and wherein the internal temperature has not been below −2° C.

The term “total shelf life” as used herein refers to the total number of days from the initial day of packaging a food product that the packaged food product may be stored or displayed until it deteriorates sufficiently to be hazardous to health (e.g., if consumed) or commercially unacceptable for sale. The total shelf-life may collectively include the number of days to transport, store, distribute, and retail display the packaged food product.

The term “film” as used herein is used in a generic sense to include plastic web, which includes, but is not limited to, a laminate, sheet, web, coating, and/or the like, that can be used to package a product. The film can be rigid, semi-rigid, or flexible.

As used herein, the term “oxygen-permeable” as applied to films and/or layers refers to a film packaging material that can permit the transfer of oxygen from the exterior of the film (i.e., the side of the film not in contact with the packaged product) to the interior of the film (i.e., the side of the film in contact with the packaged product). In some embodiments, “oxygen-permeable” can refer to films or layers that have a gas (e.g., oxygen) transmission rate of at least about 10,000 cc (standard temperature and pressure (STP))/m²/24 hrs/1 atm; in some embodiments, at least about 11,000 cc(STP)/m²/24 hrs/1 atm; in some embodiments, at least about 12,000 cc(STP)/m²/24 hrs/1 atm; in some embodiments, at least about 13,000 cc(STP)/m²/24 hrs/1 atm; in some embodiments, at least about 14,000 cc(STP)/m²/24 hrs/1 atm; in some embodiments, at least about 15,000 cc(STP)/m²/24 hrs/1 atm; in some embodiments, at least about 16,000 cc(STP)/m²/24 hrs/1 atm; in some embodiments, at least about 17,000 cc(STP)/m²/24 hrs/1 atm; in some embodiments, at least about 18,000 cc(STP)/m²/24 hrs/1 atm; in some embodiments, at least about 19,000; in some embodiments, at least about 20,000 cc(STP)/m²/24 hrs/1 atm; and in some embodiments, at least about 21,000 cc(STP)/m²/24 hrs/1 atm. In an embodiment, the oxygen permeable film is not perforated.

The term “oxygen transmission rate” or “OTR” or “oxygen permeability” is measured according to ASTM D3985 (latest version as the filing of this disclosure), a test known to those of ordinary skill in the art, and which is hereby incorporated by reference in its entirety. Unless otherwise stated, OTR values provided herein are measured at 0% relative humidity and at a temperature of 23° C.

The term “package” as used herein refers to packaging materials configured around an article being packaged. More particularly, the term “package” as used herein refers to any means for holding a product (such as raw meat) including but not limited to a container, carton, casing parcel, holder, tray, flat, bag, film, envelope, and the like. In some embodiments, the term “package” can refer to the combination of all of the various components used in the packaging of a product, i.e., all components of the packaged product other than the product within the package. The package is inclusive of, for example, a support member and all films used to surround the product and/or support member. In some embodiments, the package can also be inclusive of an oxygen absorbent component such as a sachet containing an oxygen scavenger, and the atmosphere within the package, together with any additional components used in the packaging of the product.

The term “seal” refers to any seal of a first region of a film surface to a second region of a film surface, wherein the seal is formed by heating the regions to at least their respective seal initiation temperatures. The heating can be performed by any one or more of a wide variety of manners, such as using a heated bar, impulse electrical energy, hot air, infrared radiation, radio frequency radiation, etc.

As used herein, the term “oriented” refers to a thermoplastic web which forms a film structure in which the web has been elongated in either one direction (“uniaxial”) or two directions (“biaxial”) at elevated temperatures followed by being set in the elongated configuration by cooling the material while substantially retaining the elongated dimensions. This combination of elongation at elevated temperatures followed by cooling causes an alignment of the polymer chains to a more parallel configuration, thereby improving the mechanical properties of the polymer web. Upon subsequently heating of certain unrestrained, unannealed, oriented sheet of polymer to its orientation temperature, heat shrinkage may be produced.

As used herein, the phrase “heat-shrinkable” is used with reference to films which exhibit a total free shrink (i.e., the sum of the free shrink in both the machine and transverse directions) of at least 10% at 185° F., as measured by ASTM D2732, which is hereby incorporated, in its entirety, by reference thereto. All films exhibiting a total free shrink of less than 10% at 185° F. are herein designated as being non-heat-shrinkable. The heat-shrinkable film can have a total free shrink at 185° F. of at least 15%, or at least 20%, or at least 30%, or at least 40%, or at least 45%, or at least 50%, or at least 55%, or at least 60%, or at least 65%, or at least 70%, as measured by ASTM D2732. Heat shrinkability can be achieved by carrying out orientation in the solid state (i.e., at a temperature below the glass transition temperature of the polymer). The total orientation factor employed (i.e., stretching in the transverse direction and drawing in the machine direction) can be any desired factor, such as at least 2×, at least 3×, at least 4×, at least 5×, at least 6×, at least 7×, at least 8×, at least 9×, at least 10×, at least 16×, or from 1.5× to 20×, from 2× to 16×, from 3× to 12×, or from 4× to 9×.

### II. Embodiments of the Packaging System

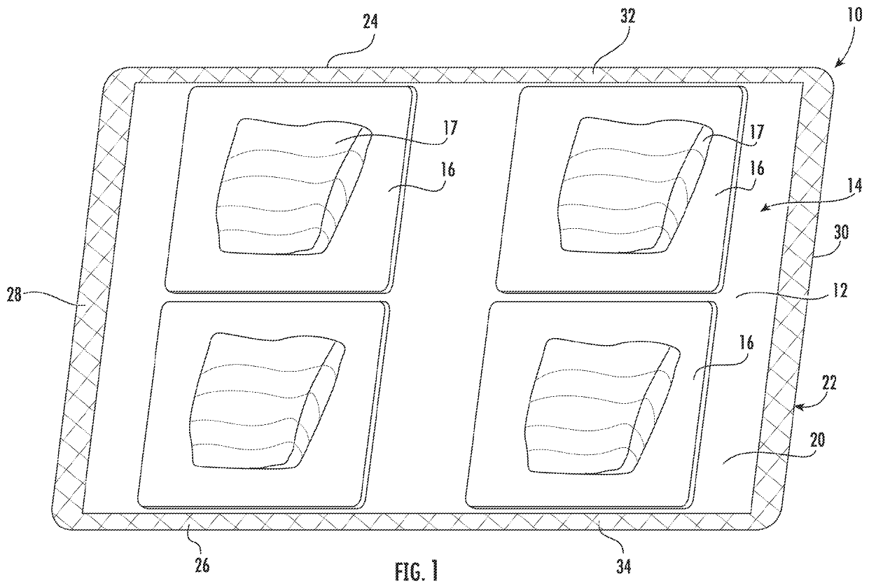

With reference to FIG. 1, a system for packaging and transporting a fresh food product is shown and broadly designated by reference character 10. The system includes a pouch 12, also referred to herein as a “master pouch” having an interior space 14 in which a plurality of individual packages 16 are disposed. Each individual package 16 includes a food product 17, such as a fish filet. The master pouch has gas barrier properties so as to limit the ingress/egress of gases through the master pouch. Each individual package 16 comprises a gas permeable film having high gas transmission properties so that gases within the interior space of the master pouch can permeate through the gas permeable film.

The interior space 14 of the master pouch includes a modified atmosphere comprising carbon dioxide (CO₂) as the primary component, and in which the residual oxygen content of the modified atmosphere has been reduced to 0.1% or less, based on the total gas content of the modified atmosphere by volume. In an embodiment, the interior space 14 of the master pouch includes a modified atmosphere comprising less than 0.4% carbon monoxide (CO). In an embodiment, the interior space 14 of the master pouch includes a modified atmosphere comprising less than 0.4% CO, a mixture of CO₂ and Nitrogen (N₂) and less than 0.1% residual oxygen. In an embodiment the mixture of CO₂ and N₂ includes at least 30% CO₂. In an embodiment the mixture of CO₂ and N₂ includes at least 50% CO₂. In an embodiment the mixture of CO₂ and N₂ includes at least 70% CO₂. In an embodiment, the interior space 14 of the master pouch includes a modified atmosphere comprising less than 0.4% CO, 99.6% CO₂ and less than 0.1% residual oxygen. In an embodiment the mixture of CO₂ and N₂ is includes 25%-100% CO₂ and the balance N₂. In an embodiment the mixture of CO₂ and N₂ is includes 20%-30% CO₂ and the balance N₂. In an embodiment the mixture of CO₂ and N₂ is includes 40%-60% CO₂ and the balance N₂. In an embodiment the mixture of CO₂ and N₂ is includes 70%-80% CO₂ and the balance N₂. In an embodiment the mixture of CO₂ and N₂ is substantially all CO₂.

As explained in greater detail below, it has been found that packaging certain fresh food products, such as fish, using a system in accordance with embodiments of the present disclosure may help to extend the shelf-life of the packaged product without resorting to freezing of the food product. For example, it has been observed that in the packaging of fish products, the total shelf-life of the product may be extended from 20 to 35 days, and in particular, from 27 to 34 days, following the initial day of packaging. This shelf-life extension is particularly beneficial under circumstances where the fresh food product is harvested, packaged, and transported from locations that are geographically remote from the final retail destination, such as a grocery store.

A. The Master Pouch

In certain embodiments, the master pouch 12 comprises front and back sheets 20, 22 that are arranged in opposing face-to-face relation with each other and are interconnected to define the interior space 14 of the master pouch. The master pouch includes a top end 24, a bottom end 26, and a pair of opposing side seams 28, 30 that extend longitudinally between the top and bottom ends of the master pouch. In the illustrated embodiments, the top end of the pouch is sealed with top seam 32 and the bottom end of the bag is sealed with bottom seam 34. In the context of the disclosure, the term “pouch” is used in a generic sense and should be recognized to include, sacks, bags, satchels, packages, containers, and the like.

As described in greater detail below, the front and back sheets 20, 22 each individually comprise a flexible film comprised of a polymeric material having gas, such as oxygen, barrier properties. In an embodiment, the films comprising the front and back sheet each include liquid, moisture vapor, and gas barrier properties.

In the embodiment shown in FIG. 1, the master pouch is shown in a sealed state with the plurality of individual packages disposed in the interior space of the pouch. As discussed below, embodiments of the master pouch can be prepared in which one of the ends of the master pouch (e.g., the top or bottom end) is left open during manufacturing so as to provide an opening through which individual packages can be introduced into the master pouch during the packaging process. The opening can then be sealed with a heat seal after one or more individual packages have been introduced into the interior space of the master pouch.

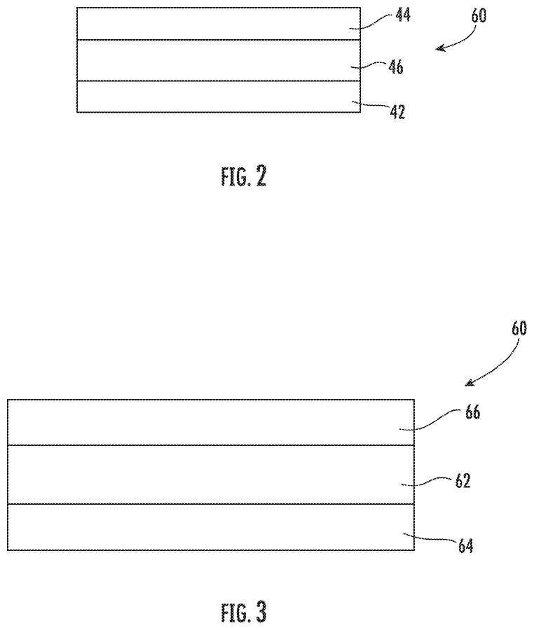

The front and back sheets of the master pouch may comprise a monolayer film, multilayer film, or a laminate. In certain embodiments, the multilayer film of the master pouch comprises a multilayer film having low oxygen permeability. In this regard, FIG. 2 illustrates an exemplary multilayer film 40 that may be used for one or more of the front and back sheets of the master pouch. The multilayer film 40 includes a first outer layer 42, also referred to as a “sealant layer”, a second outer layer 44, also referred to as an “outer abuse layer”, and at least one oxygen barrier layer 46.

In some embodiments, the master pouch is prepared from a laminate having at least one oxygen barrier layer. For example, the laminate may comprise a multilayer structure comprising one or more film layers that are adhesively bonded to each other. In certain embodiments, the laminate may comprise a multilayer film having one or more barrier layers, a sealant layer, and one or more functional layers.

The oxygen barrier layer or combination of oxygen barrier layers typically have low oxygen permeability. For example, the oxygen barrier layer(s) may have an oxygen transmission rate of 50 cc(STP)/m²/24 hrs/1 atm or less, and in particular, less than 45, less than 40, less than 35, less than 30, less than 25, less than 20, less than 15, less than 10, less than 8, and less than 5 cc(STP)/m²/24 hrs/1 atm. In some embodiments, the sealed master pouch has an OTR from about 0.01 to 5 cc(STP)/m²/24 hrs/1 atm., and in particular, from about 0.1 to 2 cc(STP)/m²/24 hrs/1 atm.

In particular, film 40 can be any suitable barrier film that is substantially impermeable to gas (such as oxygen). In one embodiment, the oxygen barrier polymer may be selected from the group consisting of polyvinyl alcohol, ethylene vinyl alcohol copolymer, polyamide, polyvinyl chloride and its copolymers, polyvinylidene dichloride and its copolymers, polyacrylonitrile and its copolymers and polyvinylidene chloride methyl acrylate. Other suitable polymers may include poly(vinyl alcohol) (PVOH), polyethylene terephthalate (PET), polyethylene naphthalate (PEN), silica (SiOₓ), and polyamides such as polycaprolactam (nylon 6), metaxylylene adipamide (MXD6), hexamethylene adipamide (nylon 66), amorphous polyamides such as nylon 6I,6T, as well as various amide copolymers and various blends of the above. Additional oxygen barriers include metal foil layers, metal coatings, depositions of metal, metal oxides such as silica (SiOₓ), alumina, nano clays and vermiculite can also provide oxygen barrier properties.

Although FIG. 2 illustrates a three layer film, it should be recognized that the film may include any number of layers depending on the intended use and desired properties provided the low oxygen permeability of the film is maintained. For example, the film may include additional functional layers and tie layers. In certain embodiments, the film may include from 1 to 10 layers, from 2 to 8 layers, and from 2 to 6 layers.

Generally, the overall thickness of the film 40 may range from between about 0.5 to 30 mils, and in particular between about 2 to 10 mils, such as from about 2 to 6 mils. In certain embodiments, the thickness of the film may be from about 2 to 3 mils.

In one embodiment the films defining the front and back sheets 20, 22 are superimposed opposite to each other and are then joined to each other along the opposed side seams 28, 30. The side seams, as well as the other seams of the pouch to be described presently, can be formed by any of various methods conventionally used in the packaging industry provided the seams are substantially impervious to the ingress/egress of liquids and gases. In an embodiment, the various seams are substantially impervious to gases such as moisture vapor, oxygen, carbon dioxide, etc. Suitable methods for forming the seams may include adhesive or fusion bonding, such as by forming seals with heat or ultrasonic energy. In the particular embodiment illustrated, the front and back sheets are made from a heat sealable material and the various seams are formed by producing a fusion bond or heat seal between contacting interior surfaces of the front and back sheets using pressure and heat or ultrasonic energy as is well known. Although referred to herein as “heat seals”, it should be understood that this term is intended to apply both to seals formed by heating the contacting surfaces with a heated anvil or platen, as well as to heating and fusion produced by other methods, such as application of ultrasonic energy.

During manufacturing of the master pouch, one of the ends of the pouch (e.g., the top end 24 or the bottom end 26) is typically open so that an opening is provided for introducing the individual packages into the interior space of the master pouch. After the individual packages are introduced into the master pouch, a heat seal can be used to bond the inner surfaces of the front and back sheets to each other and thereby form top seam 24 or bottom seam 26.

Alternatively, a master pouch can be prepared from a single sheet of film in which the film is center folded to form a c-fold in the film, which in turn defines the front and back sheets disposed opposite each other. In other embodiments, the front and back sheets may be formed from a blown film having a tubular shape in which the tube is cut transversely at predefined lengths to define the opposing top and bottom ends of each master pouch.

B. Individual Packages

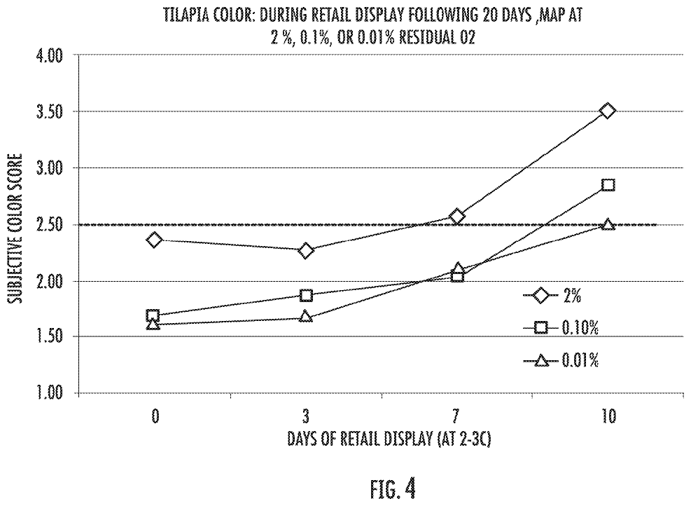

Referring back to FIG. 1, the master pouch includes one or more individual packages 16 comprising a food product 17 packaged therein. The individual packages comprise a film that is permeable to oxygen and carbon dioxide. With reference to FIG. 3, a cross-section of a three layer film 60 that may be used in preparation of the individual packages 16 is shown. Film 60 may include a core layer 62, outer sealant layer 64, and outer abuse layer 66.

Although FIG. 3 illustrates a three layer film, it should be recognized that the film may include any number of layers depending on the intended use and desired properties provided the high oxygen permeability of the film is maintained. For example, the film may include additional functional layers and tie layers. In certain embodiments, the film may include from 1 to 10 layers, from 2 to 8 layers, and from 2 to 6 layers.

In particular, the film of the individual packages has an oxygen transmission rate of at least 10,000 cc(STP)/m²/24 hrs/1 atm, and in particular, at least 11,000, at least 12,000, at least 13,000, at least, 14,000, at least 15,000, at least 16,000, at least 17,000, at least 18,000, at least 19,000, at least 20,000, at least 21,000, at least 22,000, at least 23,000, at least 24,000, and at least 25,000 cc(STP)/m²/24 hrs/1 atm. In some embodiments, the film comprising the individual packages has an OTR from about 10,000 to 40,000 cc(STP)/m²/24 hrs/1 atm., and in particular, from about 17,000 to 25,000 cc(STP)/m²/24 hrs/1 atm.

The thickness of the oxygen permeable film may be any total thickness desired, so long as the film provides the desired properties for the particular packaging operation in which the film is used. In certain embodiments, the oxygen permeable film has a thickness from about 1 to 6 mils, and in particular, from about 1.5 to 4 mils, and more particularly, from about 1.8 to 3.5 mils.

The one or more individual packages 16 may be prepared using conventional packaging techniques known in the art. In one embodiment, the one or more individual packages 16 may comprise a vacuum shrink bag (VSB) or a vacuum skin package (VSP), including a thermoformed vacuum skin package (T-VSP). Examples of suitable films that may be used in the preparation of VSB, VSP, and thermoformed VSP are described in U.S. Pat. No. 7,338,708, the contents of which is hereby incorporated by reference.

In one embodiment, the individual package 16 comprises a thermoformed VSP having a rigid or semi-rigid support member onto which an oxygen permeable lidding film has been formed and vacuum sealed.

In certain embodiments, the support member comprises a web that is thermoformed to form individual trays onto which a food product is positioned. The support member may comprise a film material that is oxygen permeable or oxygen impermeable. The oxygen permeable lidding generally comprises a film as described above. In particular, the film defining the lidding of the thermoformed VSP individual package 16 has an OTR of at least 10,000 cc(STP)/m²/24 hrs/1 atm. In an embodiment, the film has a three layer structure having an outer sealant layer comprising a blend of a linear low density polyethylene/hexane copolymer and low density polyethylene with silica; a core layer comprising a very low density polyethylene/octene copolymer, and an outer layer comprising a polymeric blend of a high density polyethylene and low density polyethylene with silica.

In certain embodiments, the individual package 16 may be prepared using a thermoforming process in which a high OTR (>10,000 cc(STP)/m²/24 hrs/1 atm) film is used to form a thermoformed support, such as a pocket or cavity, to receive the food product therein, and a second high OTR film is then sealed to the support to enclose the food product within the package. The two high OTR films may be identical or different from each other.

C. Modified Atmosphere

As discussed previously, the master pouch comprises a modified atmosphere package (“MAP”) in which the interior space of the master pouch comprises an atmosphere that has low residual oxygen.

In MAP packaging, prior to sealing the opening to the master pouch ambient air is evacuated from the interior of the master pouch and replaced with a gas that differs from ambient air. For example, the packaged food products can be packaged in a low-oxygen environment (e.g., high levels of carbon dioxide) after evacuating all or most of the air from the package. Alternatively, individual packages 16 can be exposed to carbon dioxide, then packaged in a low oxygen MAP, as would be well known to those of ordinary skill in the packaging art. MAP systems are well known to those of ordinary skill in the art. Examples of such MAP packaging are disclosed in U.S. Pat. No. 5,686,126 to Noel et al. and U.S. Pat. No. 5,779,050 to Kocher et al., the entire disclosures of which are hereby incorporated by reference.

In certain embodiments, the modified atmosphere in the master pouch is from about 30 to 99.99% carbon dioxide by volume. In embodiments wherein a fresh fish product is to be packaged, the amount of residual oxygen removed can range from about 99% to about 99.999%, and in some embodiments from about 99.5% to about 99.999% by volume. Thus, in some embodiments, the oxygen level within the master pouch can be reduced to a first level in the range of less than 0.1% and in some embodiments less than 0.01%. The reduction in oxygen level can be accomplished using one or more techniques, including but not limited to, evacuation, gas flushing, oxygen scavenging or combinations thereof.

In certain embodiments, the modified atmosphere in the master pouch comprises carbon dioxide (CO₂) as the primary component, and in which the residual oxygen content of the modified atmosphere has been reduced to 0.1% or less, based on the total gas content of the modified atmosphere by volume. In an embodiment, the modified atmosphere in the master pouch includes a modified atmosphere comprising less than 0.4% carbon monoxide (CO). In an embodiment, the modified atmosphere in the master pouch includes a modified atmosphere comprising less than 0.4% CO, a mixture of CO₂ and Nitrogen (N₂) and less than 0.1% residual oxygen. In an embodiment the mixture of CO₂ and N₂ includes at least 30% CO₂. In an embodiment the mixture of CO₂ and N₂ includes at least 50% CO₂. In an embodiment the mixture of CO₂ and N₂ includes at least 70% CO₂. In an embodiment, the modified atmosphere in the master pouch includes a modified atmosphere comprising less than 0.4% CO, 99.6% CO₂ and less than 0.1% residual oxygen.

The master pouch having the modified atmosphere comprised of carbon dioxide can then be stored/transported under refrigeration for several weeks prior to being offered for sale at a retail establishment. For example, the master pouch may be stored/transported under refrigeration (e.g., at a temperature from −1.5 to −0.5° C.) prior to retail display for up to a total of 32 days, a total of 31 days, a total of 30 days, a total of 29 days, a total of 28 days, a total of 27 days, a total of 26 days, a total of 25 days, a total of 24 days, a total of 23 days, a total of 22 days, a total of 21 days, and up to a total of 20 days. In certain embodiments, the master pouch may be stored/transported under refrigeration (e.g., at a temperature from −1.5 to −0.5° C.), prior to retail display for an amount of time ranging from about 10 to 30 days, and in particular, from about 14 to 28 days, and more particularly, from about 21 to 28 days. In an embodiment, the master pouch may be stored/transported under refrigeration (e.g., at a temperature from −1.5 to −0.5° C.), prior to retail display for an amount of time ranging from about 20 to 25 days.

D. Additional Components

In certain embodiments, it may be desirable to use oxygen absorbers in order to reduce the residual oxygen concentration in the interior space of the pouch to a level of 0.1% or less. In one embodiment, the oxygen absorber may comprise a satchel comprising a chemical composition that scavenges oxygen molecules. Suitable oxygen scavenging compositions may be based on iron, magnesium, copper, enzymes, and mixtures thereof. A commercial example of a suitable oxygen absorber is available from Mitsubishi Gas Chemical America under the product name AGELESS® Oxygen Absorber ZPT-100 MBC.

In addition to oxygen absorbers, systems in accordance with embodiments may also include a Time-Temperature Indicator (TTI) device that has been introduced into the master pouch, or that is positioned in a temperature monitoring relationship with the master pouch. For example, the TTI device may be affixed to an exterior surface of the master pouch. The TTI device provides a rapid initial determination as to whether the temperature to which the master pouch, and hence its contents, may have exceeded a predetermined threshold.

Time-Temperature Indicators that may be used include a broad range of devices that can visually indicate a cumulative time-temperature exposure or temperature history of the packaged food products. TTIs typically indicate that a temperature threshold may have been exceeded by producing a visual physical change, such as a change in color. TTIs may use a mechanical, chemical, electrochemical, enzymatic, or microbiological change to indicate through a visible response that the predetermined threshold may have been exceeded. The visible response may be expressed in the form of a mechanical deformation, color development, or color movement. In some embodiments, the TTI may use a diffusion based indicator, enzymatic indicator, or polymerization based indicator.

Typically, TTI devices can be configured to show a visual change at a predetermined time-temperature threshold. The predetermined threshold for the label may be the same or different than the expiration threshold of the object being monitored. An appropriate TTI device can be selected based on a desired time-temperature threshold and the specific nature of the packaged food products.

In some embodiments, the TTI label can produce a visual response immediately after being exposed to a predetermined temperature. In other embodiments, the TTI label may produce a visual response only after prolonged exposure to the predetermined temperature. In still other embodiments, the TTI label may produce a scaled visual change that can be compared to a reference scale. The scale can be used to make an initial determination of the duration and extent of temperature exposure. Exemplary TTI devices are described in U.S. Pat. Nos. 5,368,905; 5,057,434; 5,667,303; 5,709,472; 6,042,264; and 6,544,925.

Advantageously, embodiments described herein may be helpful in extending the shelf-life of a food product. In particular, the high permeability of the individual packages containing the food product permits the CO₂ gas in the modified atmosphere to permeate through the film and contact the surface of the food product. While not being wish to be bound by theory, it is believed that the CO₂ forms carbonic acid when in contact with the food product. This in turn, lowers the pH of the food product, which helps to provide a bacteriostatic effect to reduce the growth of bacteria. Upon reaching a distribution point or final retail outlet, such as a grocery store, the individual packages are removed from the master pouch and made available for retail display. In some embodiments, the individual packages containing the food product have from 5 to 10 remaining days of shelf-life following removal from the master pouch.

The system and method are particularly advantageous for the packaging and transport of fish food products, such as fish fillets. In particular, the individual packages of fish fillets can be packaged and transported in the master pouch at temperatures ranging from 0 to −1.5° C., and in particular, from −0.5 to −1.5° C. At these temperatures, the tissue of the fish food product is not adversely affected, but the growth of bacteria and other undesirable microorganisms is substantially reduced and/or inhibited.

In an embodiment, a method of shipping or transporting the master pouch comprising the packaged food products in the master pouch. Embodiments also include the distribution of such master pouches to retail establishments, such as grocery stores, the removal of the individual packaged food products from the master pouch, and the retail display for consumer purchase at the retail establishments.

Although the method and system have generally been described with respect to the packaging of fish as the fresh food product, it should be recognized that other food products may be encompassed. For example, the system and method may be used to package other protein based food products, such as beef, veal, pork, sausage, cured meats, chicken, lamb, bison, goat, fowl, such as turkey, and the like. Examples of fish include tuna, salmon, tilapia, haddock, cod, trout, halibut, catfish, bass, snapper, grouper, sea bass, flounder, lion fish, perch, pollock, shark, squid, walleye, pike, wahoo, blue fish, marlin, amberjack, cobia, sake, mackerel, mahi mahi, octopus, swordfish, shrimp, lobster, crab, shellfish and the like.

Food products may be arraigned individually in packages, arranged as multiples in a package, stacked in layers and such.

### EXAMPLES

Packaging Equipment

A. Vacuum Packaging Machine

The Ultravac 2100, obtained from UltraSource, was used to prepare the vacuum packages containing the food product. The machine has one upper vacuum chamber and two lower chamber each with impulse sealing. The top chamber can swing onto one lower chamber to vacuumize a “bag” (shrink tubing with one end seal) by drawing the air from the open end of the bag. The other uncovered lower chamber can be loaded with bags for the next cycle while in process of evacuating and sealing on the adjacent lower chamber. The impulse seal provides a hermetic seal to the open end of the bag, followed by venting to atmosphere to remove and shrink the bag over the food within.

Optionally, the vacuum sealed packages can be treated with hot water shrink the film about the food product (e.g., a hot water dip or a hot water tunnel can be employed).

B. Thermoformed-Vacuum Skin Packaging

An ULMA/Sealed Air Cryovac DARFRESH® Vacuum Skin Packaging Machine model TFS 707 was used to prepare the thermoformed vacuum skin packages. In this process, a flexible top film (crosslinked) comprising an oxygen permeable film is preheated between 100-150° C.), and then advanced forward under a heated dome (approximately 200° C.) with a bottom film or formed trays underneath the food product to be skin packaged. The top film is drawn by vacuum upwards into the dome, and immediately thereafter the space around the food is evacuated. Once a certain vacuum pressure has been reached, the top film is released by venting atmospheric air to the top of the dome, thereby collapsing the superheated film onto the food (i.e. skin packaging) and the space around the food is hermetically seal by the latent heat within the film and absence of air due to vacuum pressure. The sealed trays are indexed forward through longitudinal and transverse knives to cut the packages to their final dimensions.

Modified Atmosphere Equipment

The modified atmosphere in the master pouches was produced with a M-Tec Corr-Vac Gas Flushing Device. The M-Tek equipment is designed to evacuate a flexible bag or pouch of the internal air, and backflush with a treatment gas. The gas can be high oxygen such as to keep red meats red or can be a low oxygen gas (nitrogen or CO₂ or a mixture) for an anaerobic package for preservation of a food. A gas bottle or a gas source tank is connected to the machine via a hose and a regulator. The opening of the pouch is positioned past the seal bar (can be either impulse seal or hot bar seal-out unit is designed with impulse sealing) and over the evacuation paddles. The “paddles” extend forward into the bag once the cycle begins, by clamping the seal bar closed, to initially evacuate the bag or pouch. The “paddles” have grooves so that as the evacuation nears completion and the material collapses upon itself, these grooves create channels to continue the evacuation. After a programmed vacuum time, the treatment gas is flooded into the bag via a gas connection to the same “paddles”. A second or third vacuum cycle can be programmed for more efficient flushing as needed. The gas is metered into the bag or pouch by a time setting and then the bag or pouch is heat sealed and the cycle is completed.

In the examples, it was found that the device was only capable to achieve a residual oxygen content of about 2%, even with a dual vacuum/flush program. To achieve lower residual oxygen levels, a manual method was used to seal the bag or pouch with a 1″ gap to insert a gas hose to fill the bag or pouch, while another individual would “burp” the gas out to achieve a low oxygen level. The gas hose was removed a fraction of a second before the sealing bar was engaged to prevent back pressure of atmospheric air to maintain the low level (>0.1%). Oxygen absorbers were used to reduce the oxygen level below 0.01% (100 ppm).

Additionally, an M-Tek Horizontal Flow Packer (model HFP) was designed and tested with one vacuum nozzle positioned to one side of the open pouch and a gas lance that extends into the bottom of the pouch, on the opposite side of the pouch. It was found this machine design achieved a 0.1% residual oxygen upon purging a low oxygen gas into the bottom of the pouch while simultaneously evacuation from the open end of the pouch, creating a flow of gas. Adding additional cycles of gas then vacuum improved the final residual oxygen level to near 0% oxygen. After the final gas cycle to achieve the proper volume of gas within the pouch, the gas lance and vacuum nozzle retract to heat seal the pouch.

Test Materials

The following materials were used in the preparation of the following samples

Fish Fillets

Tilapia Fillets

Tilapia fillets 1 were obtained live from Astor Farms in Charlotte, N.C.

The fish were cleaned and filleted at the Sealed Air facility, and exhibited a starting microbial counts of approximately Log 2 CFU/g.

Tilapia Fillets 2 were obtained from a supplier in Costa Rica, and were air freighted to the Sealed Air Facility in Charlotte, N.C. The fillets exhibited a starting microbial count of approximately Log 2 CFU/g.

Salmon Fillets

Salmon fillets 1 were obtained as whole, cleaned salmon from a fish farm in Seattle, Wash. The salmon were filleted at the Sealed Air facility, and exhibited a starting microbial counts of approximately Log 2 CFU/g.

Salmon Fillets 2 were obtained as fillets from a supplier in Chile, and air freighted to the Sealed Air Facility in Charlotte, N.C. The fillets exhibited a starting microbial count of approximately Log 2 CFU/g, with suboptimal color.

Salmon Fillets 3 were obtained as whole, cleaned salmon from a fish farm in Seattle, Wash. The salmon were filleted at the Sealed Air facility, and exhibited a starting microbial count of approximately Log 1.6 CFU/g.

Thermoformed Vacuum Skin Packaging (T-VSP)

The thermoformed vacuum skin packages were prepared from an oxygen permeable lidding film having an OTR of 10,000 cc(STP)/m²/24 hrs/1 atm that was attached to a semi-rigid bottom web onto which the filet was positioned during the packaging process. A VSP/DARFRESH® packaging system, manufactured by Ulma was used to prepare the thermoformed vacuum skin packages. During the packaging process, the film is pulled by vacuum upwards into a Teflon coated heated dome (200° C.+/−5 C) to superheat the film as it seals to the bottom web only by evacuation of the space between the films. Latent heat transferred to the film prior to venting and collapse over the food and bottom web results in sealing the lidding to the bottom web to thereby create the skin packaged effect.

The oxygen permeable film of the lidding had the following three layer structure:

Layer 1 comprised a sealant layer having a thickness of 0.08 mil, and comprised a polymer blend of 95% by weight of Linear Low Density Polyethylene/Hexene Copolymer (0.918 g/cm³), and 5% Low Density Polyethylene (0.97 g/cm³) blended with silica.

Layer 2 defined a core layer of the film having a thickness of 2.80 mils. Layer 2 comprised a Very Low Density Polyethylene/Octene Copolymer (0.87 g/cm³).

Layer 3 defined an outer abuse layer having a thickness of 0.07 mils, and comprised a blend High Density Polyethylene (0.956 g/cm³) 95% by weight, and Low Density Polyethylene (0.956 g/cm³) with silica.

The film had a total thickness 2.95 mils.

The bottom film web from which the support member was formed comprised a 16 mil barrier web thermoformed into trays on the thermoforming VSP machinery. The bottom web had the following seven layer structure:

Layer 1 comprised a blend of ethylene vinyl acetate and polybutylene having a thickness of 0.3 mils;

Layer 2 comprised a linear low density polyethylene having a thickness of 0.3 mils;

Layers 3 and 5 comprised a linear low density polyethylene having a thickness of 0.16 mils;

Layer 4 comprised ethylene vinyl alcohol having a thickness of 0.2 miles;

Layer 6 comprised a blend of linear low density polyethylene and low density polyethylene having a thickness of 0.82; and

Layer 7 comprised a second outer layer of the web, and comprised a semi-rigid PVC sheet having a thickness of 14 mils.

The bottom web had a total thickness of 16 mils, an OTR of 10 cc(STP)/m²/24 hrs/1 atm.

The bottom web was formed into a tray on the ULMA VSP machine upon heating with a flat heated plate, and subsequently vacuum forming into a tray mold below. The bottom web was restrained by gripper chains to advance the forming web forward, and the tray molds are removable to change outer perimeter size as well as depth of draw.

Vacuum Shrink Bag (VSB)

Samples were prepared with a vacuum shrink bag comprising an oxygen permeable film having an OTR of 10,000 cc(STP)/m²/24 hrs/1 atm. The film was an oriented film that was made into an individual bags having a heat seal at one end, and open end at the other end through which the fish fillets were introduced into the bags. The air within each bag was evacuated within a vacuum chamber and the opening was sealed with a heat seal. Upon exposure to heated water, the shrink bags shrink about, and conform to the shape, of the packaged fillets. The shrink bags in the examples had the following three layer structure:

Layer 1 comprised a sealant layer having a thickness of 0.08 mil. Layer 1 comprised a blend of 80%, by weight of Very Low Density Polyethylene/Octene Copolymer (0.90 g/cm³), 20%, by weight of Linear Low Density Polyethylene (0.918 g/cm³);

Layer 2 comprised a core layer of the film, and comprised an ethylene/butyl acrylate copolymer having a 0.927 density of g/cm³, and a thickness of 1.83 mils;

Layer 3 defined the second outer layer of the film, and comprised a blend of a very low density polyethylene (84% by weight) having a density of 0.902 g/cm³, a low density polyethylene/octene copolymer (15% by weight) having a density of 0.92 g/cm³, and a blend of a fluoropolymer in linear low density (1% by weight) having a density of 0.92 g/cm³.

The film had a total thickness of 1.99 mils.

4 K OTR BAG

The 4 K OTR Bag comprised an oriented shrink bag having an OTR of approximately 4,000 cc(STP)/m²/24 hrs/1 atm. The bag was prepared from an extruded tubular tape having an initial thickness of about 22.5 mils thickness. The tape was crosslinked and then hot blown to orient in the film in the transverse and longitudinal directions of the tubing. Following orientation, the film had a thickness of approximately 2 mils. The tubing was then made into individual bags with an impulse seal at one end. The open end was used to introduce a sample fillet into the bag during vacuum packaging. The opened was closed with an impulse seal. The material is shrinkable in hot water; however, the prepared samples were not shrunk in order to preserve the oxygen transmission rate.

The film had the following structure:

Layer 1 defined an outer sealant layer comprised of a linear low density polyethylene (thickness of approximately 0.31 mils); and

Layers 2 and 3 comprised a blend of linear low density polyethylene and very low density polyethylene (thickness of approximately 1.09 mils and 0.60 mils, respectively).

17 k OTR BAG

The 17 K OTR Bag comprised an oriented shrink bag having an OTR of approximately 17,000 cc(STP)/m²/24 hrs/l atm. The material is shrinkable in hot water; however, the prepared samples were not shrunk in order to preserve the oxygen transmission rate. The film was folded, and sealed on two edges to make into bags, and after introduction of fish fillets into the pre-made bags, the open end was sealed on the vacuum chamber machine by the impulse seal bar at the end of the cycle. The film had a total thickness of about 0.3 mils.

The film had the following structure:

Layer 1 comprised a blend of medium density polyethylene, ethylene vinyl acetate, and an ethylene copolymer (thickness of approximately 0.06 mils);

Layer 2 comprised linear low density polyethylene (thickness of approximately 0.06 mils);

Layer 3 comprised a blend of linear low density polyethylene and medium density polyethylene (thickness of approximately 0.12 mils); and

Layer 4 comprised a blend of medium density polyethylene, ethylene vinyl acetate, and an ethylene copolymer (thickness of approximately 0.06 mils).

Barrier Bag (BB Bag)

The BB Bag used in the examples below comprised a film having an oxygen barrier layer, which prevented atmospheric oxygen and CO₂ from entering or permeating the package after evacuation. The packages comprising the barrier bags provided an anaerobic environment. Testing was done with Barrier Bags on fish fillets to demonstrate the difference in shelf-life with a vacuum anaerobic package vs. a CO₂ gas flushed anaerobic package, both with an absence of oxygen.

General Structure:

Layer 1: LLDPE or VLDPE (sealant);

Layer 2: LDPE or LDPE;

Layer 3: PVdC Methyl Acrylate (oxygen barrier);

Layer 4: LLDPE or LDPE; and

Layer 5: LDPE (outer and abuse layer).

Master Pouch

The master pouches used in the examples were prepared from a three layer laminate comprised of an outer barrier/sealant layer (thickness of 1.75 mils); an adhesive layer comprised of isocyanate (thickness of 0.02 mils), and outer nylon layer (thickness of 0.75 mils).

The barrier/sealant layer comprised a coextruded film having the following seven layer structure:

Layer 1: blend of a linear low density polyethylene copolymer and a very low density polyethylene copolymer (thickness of 0.20 mils);

Layer 2: blend of a linear low density polyethylene copolymer and a low density polyethylene homopolymer (thickness of 0.30 mils);

Layer 3: low density polyethylene copolymer (thickness of 0.26 mils);

Layer 4: maleic anhydride modified polyethylene (thickness of 0.14 mils);

Layer 5: ethylene vinyl alcohol (thickness of 0.20 mils);

Layer 6: maleic anhydride modified polyethylene (thickness of 0.14 mils); and

Layer 7: blend of a linear low density polyethylene copolymer and a very low density polyethylene copolymer (thickness of 0.51 mils).

The master pouch was manufactured from two identical sheets of the above film. The two sheets of films were superimposed over each other in a face-to-face relations, and heat sealed to each other along opposing side and bottom edges to form a pouch having an opening through which the individual packages can be introduced into the interior space of the pouch. The overall dimensions of the master pouches were 22.75 inches×29 inches. The film had an OTR of 3.1 cc(STP)/m²/24 hrs/1 atm or less.

Oxygen Absorber

A sachet comprising an iron based oxygen scavenger composition obtained from Mitsubishi Gas Chemical, America under the product name AGELESS® ZPT-100MBC was used.

Test Methods

Oxygen Content

Oxygen content of the headspace of the master pouches was evaluated with a Mocon PAC CHECK model 450 Headspace Analyzer (“Mocon”). The Mocon checks residual oxygen level via a FLO SMART pump, a needle attached to a hose to draw a headspace sample from the master pouch containing the modified atmosphere, which in the examples was comprised predominately of CO₂, with a low oxygen level. The Mocon unit reads oxygen level in % until it reaches less than 0.01% as it then reads at ppm (999-0 ppm).

For testing of the master pouches flushed with CO₂ gas, the residual oxygen level provided an indicator of efficiency of flush while using a treatment gas containing 99.99% CO₂ from the vendor (Air Gas). Bags or pouches were covered with small piece of testing tape, to prevent tear propagation to the polymer film, placing the needle through the tape and pouch, pressing the “test” button to engage the pump. Once a reading was obtained, a second piece of tape was placed over the hole from the needle piercing as the needle was removed to prevent air contamination. A corner was sampled and then the corner was sealed with an impulse seal bar inside the area where the film was pierced to prevent ingress/egress of gases into and out of the sealed master pouches.

Color Appearance

A. Subjective Color Appearance

In general, the color of tilapia and salmon displays is an indication of freshness and acceptability to the consumer. As tilapia filets age, they generally have a reddish beige coloration, which turns to a yellowish gray color over time. In salmon fillets, the coloration is typically uniform with no visible blemishes. As the fillets age, the fillets begin to yellow, with deepening yellow and the appearance of blemishes, washed out orange coloring, and eventually the development of a slime coating.

The subjective color appearance for tilapia filets was performed with a four point scale. The packaged filets were evaluated by a panel of 3 to 5 food scientists that observed and ranked the filets displayed in a retail display on the following criteria. Files with a reddish beige color were ranked with a score of 1; fillets having a beige outer color and a reddish brown center were ranked with a score of 2; fillets having an outer yellowish beige color and a brown center were ranked with a score of 3; and fillets having an outer yellowish-gray appearance and a gray center were ranked with a score of 4. Fillets having a score of 1 and 2 were considered acceptable, and fillets having a scores of 3 and 4 were considered unacceptable. A score of 2.5 was considered the mid-point for acceptability of color. Retail display cases were lit with retail grade LED lighting and temperature was 2-3° C.

Color evaluations for salmon, being a different coloration, were evaluated on a 6-point scale with 1=extremely acceptable (uniform color, no blemishes); 2=moderately acceptable (slight variation in color); 3=slightly acceptable (slightly yellowing but would still acceptable to a consumer); 4=slightly unacceptable (yellowing of color evident, slight blemishes); 5=moderately unacceptable (definite yellowing, washed out orange color, blemishes evident, slime formation beginning); and 6=extremely unacceptable (yellowing is predominate, slimy-milky appearance). The same panelist were used in both the tilapia and salmon evaluations, and the same conditions of the retail display were used.

B. Hunter Lab Color Evaluation

An objective color evaluation of the packaged tilapia and salmon fillets using a HunterLab MiniScan EZ Colorimeter, Model 4500L, Hunter Associates Laboratory, Reston Va. Hunter Lab is a unit to measure color of foods and object using CIE color scale. Under this evaluation, L=lightness (white to black) and a=redness/blue and b=yellow/green. Model 4500L, Hunter Associates Laboratory, Reston Va. The set up “Color Scale” was used to generate “L” “a” and “b” values on packaged fish fillets. The procedures are to standardize the unit with black and white tiles, and then standardize to a green color tile. Three readings were taken on each fillet sample with a light source and lens covering the sample. The 3 samples are averaged. Replicate samples were averaged for reporting.

Odor Evaluation

Tilapia odor and Salmon odor of samples were evaluated with the same 4-point scale as in the Subjective Color Evaluation describe above wherein a ranking of 1=neutral, fresh odor, a ranking of 2=marine, seaweed odor, a ranking of 3=sour milk, silage odor, and a ranking of 4=acetic, putrid odor. Scores of 1 and 2 are considered acceptable and scores of 3 and 4 are considered unacceptable and this the mid-point is a score of 2.5 being marginal as to acceptability. When testing retail shelf life of fillets, color was evaluated initially within the vacuum sealed packages, or in the case of “naked fillets” from MAP, those were wrapped with 60 ga. PVC retail stretch film on EPS foam trays. Once evaluated for color, then panelist were presented with packages individually by cutting a 1-1.5″ wide hole into each package to sniff. This is the standard procedure to prevent the fillets from losing its confined odor prior to the last panelist being able to evaluate the product. Each panelist scored their numbers without viewing the other panelist scores.

Microbial Evaluation

Microbial counts of test samples were obtained in accordance with the following procedure. A 20 to 25 gram portion of each sample evaluated was diluted 1:10 with a 0.1% sterile peptone buffer, and then blended for 1 minute with an Interscience stomacher blender. The sample was the further diluted in serial aliquots of sterile Lactobacilli MRS broth for lactic acid bacteria testing, and sterile 0.1% peptone buffer for aerobic testing. The dilutions of each sample diluted in 0.1% peptone were plated, in duplicate, onto Aerobic Plate Count Petrifilm (available from 3M). The dilutions of each sample diluted in MRS broth were plated, in duplicate, onto Aerobic Plate Petrifilm. The plates containing the samples diluted in MRS broth were place in an anaerobic environment. The aerobic plates and the lactic plates were incubated for 48 hours at 35° C. Plates having a countable range of bacterial colonies were chosen from evaluation.

Salmon Test 1

In Salmon Test 1, the effects of packaging filets in individual, CO₂ permeable packages, which were then packaged in master pouch having a CO₂ modified atmosphere was evaluated for appearance, odor, and microbial count in comparison to filets package only in the permeable packages, and filets packaged in a modified atmosphere without individual packaging of each filet.

In the following examples, three sets of samples were prepared using Salmon Fillets 1. The first set of samples (identified in the tables below as T-VSP Comparative) were prepared in which the fillets were thermoformed-vacuum skin packaged as described above with no master pouch and no modified atmosphere. In the second set of samples (identified in the tables below as Naked Comparative), naked fillets were packaged in a master pouch having a modified atmosphere comprised predominately of CO₂. An oxygen absorber was added to the master pouch to decrease residual oxygen levels to 0.1% within 24 hours. In the third set of samples (identified in the tables below as T-VSP+MP) the fillets were thermoformed-vacuum skin packaged as described above, and then packaged into a master pouch having a modified atmosphere comprised predominately of CO₂. An oxygen absorber was added to the master pouch to decrease residual oxygen levels to 0.1% within 24 hours.

The various samples were then stored at temperatures from −1 to −1.5° C. to simulate cold storage during transport for up to 34 days, and then placed in a retail display at a temperature ranging from 1 to 2.5° C. to simulate typical conditions of retail display at a grocery store. For samples packaged in a master pouch, the samples were removed from the master pouch for the retail display portion of the evaluation. At various points during the cold storage, samples were removed and then placed in the retail display to evaluate the fillets for color, odor and microbial count.

In general, the values provided in Tables 1 through 5 are based on average sample counts ranging from 2 to 6 samples. The number of panelist conducting the subjective odor and color reviews ranged between 3 and 4 panelists.

TABLE 1
Color and Odor Evaluation at 5 Days Cold Storage.

| | Average | Average | Average | Average | Average | Average | | | |
|---|---|---|---|---|---|---|---|---|---|
| | Color | Color | Color | Odor | Odor | Odor | Hunter | Hunter | Average |
| | Scoring | Scoring | Scoring | Score at | Score at | Score at | Lab | Lab | Odor |
| | at 0 days | at 3 days | at 6 days | 0 days | 3 days | 6 days | Score | Score | Score |
| Sample No. | retail | retail | retail | retail | retail | retail | (L) | (a) | (b) |
| T-VSP | 1.9 | 1.75 | 2.5 | 1.0 | 1.3 | 2.6 | — | — | — |
| Comparative | | | | | | | | | |
| Sample 1 | | | | | | | | | |
| Naked | 1.8 | 2.69 | 3.5 | 1.0 | 2.1 | 1.6 | — | — | — |
| Comparative | | | | | | | | | |
| Sample 1 | | | | | | | | | |
| T-VSP + MP | 1.5 | 1.25 | 1.5 | 1.7 | 1.4 | 2.3 | — | — | — |
| Sample 1 | | | | | | | | | |

Differences in odor and color between the comparative samples (T-VSP Comparative and Naked Comparative) and the samples in accordance with embodiments were slight after only 5 days of cold storage in the CO₂ master pouch. The T-VSP Comparative samples represent the typical method of distribution and merchandising of fish fillets today, held in atmospheric air throughout the life of the product, and will typically have a 12 day maximum shelf-life.

TABLE 2
Color and Odor Evaluation at 13 Days Cold Storage.

| | Average | Average | Average | Average | Average | Average | | | |
|---|---|---|---|---|---|---|---|---|---|
| | Color | Color | Color | Odor | Odor | Odor | Hunter | Hunter | Average |
| | Scoring | Scoring | Scoring | Score at | Score at | Score at | Lab | Lab | Odor |
| | at 0 days | at 2 days | at 5 days | 0 days | 2 days | 5 days | Score | Score | Score |
| Sample No. | retail | retail | retail | retail | retail | retail | (L) | (a) | (b) |
| T-VSP | 1.8 | 2.8 | 2.6 | 1.4 | 2.0 | 2.0 | — | — | — |
| Comparative | | | | | | | | | |
| Sample 2 | | | | | | | | | |
| Naked | 1.7 | 2.8 | 2.1 | 1.8 | 1.2 | 2.1 | — | — | — |
| Comparative | | | | | | | | | |
| Sample 2 | | | | | | | | | |
| T-VSP + MP | 1.8 | 2.4 | 1.9 | 1.7 | 1.0 | 2.1 | — | — | — |
| Sample 2 | | | | | | | | | |

Following 13 days of cold storage, differences in color are emerging with T-VSP comparative fillets becoming less acceptable by day 5, whereas Naked Comparative and T-VSP samples were more acceptable on day 5 of retail display. No differences in odor were observed as all samples were acceptable over the 5 days of retail display.

TABLE 3
Color and Odor Evaluation at 20 Days Cold Storage.

| | Average | Average | Average | Average | Average | Average | | | |
|---|---|---|---|---|---|---|---|---|---|
| | Color | Color | Color | Odor | Odor | Odor | Hunter | Hunter | Average |
| | Scoring | Scoring | Scoring | Score at | Score at | Score at | Lab | Lab | Odor |
| Sample | at 0 days | at 2 days | at 5 days | 0 days | 2 days | 5 days | Score | Score | Score |
| No. | retail | retail | retail | retail | retail | retail | (L) | (a) | (b) |
| T-VSP | 2.7 | 3.4 | 3.3 | 1.8 | 3.3 | 3.1 | — | — | — |
| Comparative | | | | | | | | | |
| Sample 3 | | | | | | | | | |
| Naked | 3.1 | 2.8 | 3.6 | 2.0 | 2.0 | 2.6 | — | — | — |
| Comparative | | | | | | | | | |
| Sample 3 | | | | | | | | | |
| T-VSP + MP | 2.5 | 2.4 | 2.4 | 2.0 | 2.3 | 3.4 | — | — | — |
| Sample 3 | | | | | | | | | |

Following 20 days of cold storage and 2 days of retail display, the T-VSP Comparative samples exhibited a borderline limit of acceptability (score of 3.4) for color. The T-VSP samples, which were packaged in the master pouch with a predominately CO₂ atmosphere, were acceptable for color through day 5 of retail display. Odor scores were unacceptable for VSP comparative samples by day 2 (score >2.5) with significantly more acceptable odor for Naked and VSP+MP on day 2. However, all samples exhibited unacceptable odor by day 5.

TABLE 4
Color and Odor Evaluation at 27 Days Cold Storage.

| | | | | | | | Average | Average | Average |
|---|---|---|---|---|---|---|---|---|---|
| | | | | | | | Hunter | Hunter | Hunter |
| | | | | | | | Lab | Lab | Lab |
| | | | | | | | Score (L) | Score (a) | Score (b) |
| | | | | | | | 0 Days | 0 Days | 0 Days |
| | Average | Average | Average | Average | Average | Average | retail; | retail; | retail; |
| | Color | Color | Color | Odor | Odor | Odor | 2 Days | 2 Days | 2 Days |
| | Scoring | Scoring | Scoring | Score at | Score at | Score at | retail; | retail; | retail; |
| Sample | at 0 days | at 2 days | at 5 days | 0 days | 2 days | 5 days | 5 Days | 5 Days | 5 Days |
| No. | retail | retail | retail | retail | retail | retail | retail | retail | retail |
| T-VSP | — | — | — | — | — | — | | — | — |
| Comparative | | | | | | | | | |
| Sample 4 | | | | | | | | | |
| Naked | 2.4 | 2.0 | 3.3 | 1.9 | 1.94 | 2.00 | 46.41; | 27.52; | 26.24; |
| Comparative | | | | | | | 46.42; | 25.42; | 24.74; |
| Sample 4 | | | | | | | 47.76 | 24.1 | 23.53 |
| T-VSP + MP | 2.6 | 2.6 | 2.4 | 1.4 | 1.88 | 2.13 | 55.24; | 27.04; | 26.94; |
| Sample 4 | | | | | | | 56.50; | 26.18; | 24.74; |
| | | | | | | | 56.57 | 25.54 | 25.42 |

The T-VSP Comparative samples were removed from the testing with the 27 days storage group due to overt spoilage following the 20 day storage group. Naked and VSP+MP had acceptable color through 2 days of retail display and The T-VSP+MP samples were slightly acceptable (<2.5) on day 5, while Naked samples were judged unacceptable for color on day 5. Odor scores were similar. An explanation for the less acceptable coloration on the Naked salmon fillets was a result of free moisture, generated by the naked fillets, freezing within the master pouch at the −1.5° C. storage temperature. The formation of ice crystals inside the master pouch then seeding more ice crystals, eventually on the surface of the salmon fillets was observed, contributing to discoloration. However, freezing of fillets within the T-VSP+MP samples did not occur, as any moisture was contained within the highly oxygen permeable vacuum skin package, ensuring of a reduced freezing point from the natural salts and fats within this purge on the surface of the fillets within the package.

TABLE 5
Color and Odor Evaluation at 34 Days Cold Storage.

| | | | | | | | Average | Average | Average |
|---|---|---|---|---|---|---|---|---|---|
| | | | | | | | Hunter | Hunter | Hunter |
| | | | | | | | Lab | Lab | Lab |
| | | | | | | | Score (L) | Score (a) | Score (b) |
| | | | | | | | 0 Days | 0 Days | 0 Days |
| | Average | Average | Average | Average | Average | Average | retail; | retail; | retail; |
| | Color | Color | Color | Odor | Odor | Odor | 2 Days | 2 Days | 2 Days |
| | Scoring | Scoring | Scoring | Score at | Score at | Score at | retail; | retail; | retail; |
| Sample | at 0 days | at 2 days | at 5 days | 0 days | 2 days | 5 days | 5 Days | 5 Days | 5 Days |
| No. | retail | retail | retail | retail | retail | retail | retail | retail | retail |
| T-VSP | — | — | — | — | — | — | | — | — |
| Comparative | | | | | | | | | |
| Sample 5 | | | | | | | | | |
| Naked | 2.7 | 2.6 | 3.0 | 1.8 | 2.5 | 2.2 | 53.32; | 27.91; | 27.24; |
| Comparative | | | | | | | 50.45; | 26.64; | 26.28; |
| Sample 5 | | | | | | | — | — | — |
| T-VSP + MP | 2.8 | 3.75 | 5.0 | 2.7 | 3.6 | 3.7 | 54.50; | 26.72; | 26.18; |
| Sample 5 | | | | | | | 54.57; | 23.64; | 24.10; |
| | | | | | | | — | — | — |

In general, the results from day 34 of cold storage were reversed from the 27 day group data as the Naked samples had a more acceptable color and odor over 5 days of retail compared to the T-VSP+MP, which also correlates to the microbial data in Table 6, below. Even still, odor was marginal for the Naked sample by day 2 of retail display demonstrating the limits of cold storage in CO₂ master pouch are in the greater than 30 day timeframe to still yield an acceptable product for retail display for color, odor and microbial quality.

TABLE 6
Microbial Data for the Samples of Tables 1-5

| | Aerobic | | | Anaerobic | | |
|---|---|---|---|---|---|---|
| | Microbial Data | | | Microbial Results | | |
| | T-VSP | Naked | T- | T-VSP | Naked | T- |
| | Com- | Com- | VSP + | Com- | Com- | VSP + |
| | parative | parative | MP | parative | parative | MP |
| Count at | 2.2 | 2.2 | 2.2 | 0.9 | 0.9 | 0.9 |
| 0 days Storage | | | | | | |
| 0 days retail | | | | | | |
| (Log CFU/g) | | | | | | |
| Count at | 1.05 | 1.12 | 1.12 | 1.51 | 0.5 | 0.4 |
| 5 days Storage | | | | | | |
| 0 days retail | | | | | | |
| (Log CFU/g) | | | | | | |
| Count at | 4.12 | 2.37 | 2.37 | 3.59 | 1.88 | 2.2 |
| 5 days Storage | | | | | | |
| 3 days retail | | | | | | |
| (Log CFU/g) | | | | | | |
| Count at | 6.96 | 4.98 | 4.8 | 6.16 | 4.67 | 4.73 |
| 5 days Storage | | | | | | |
| 6 days retail | | | | | | |
| (Log CFU/g) | | | | | | |
| Count at | 4.38 | 0 | 1 | 3.65 | 0.5 | 1.58 |
| 13 days Storage | | | | | | |
| 0 days retail | | | | | | |
| (Log CFU/g) | | | | | | |
| Count at | 6.11 | 1.65 | 1.08 | 5.46 | 1.25 | 1.0 |
| 13 days Storage | | | | | | |
| 2 days retail | | | | | | |
| (Log CFU/g) | | | | | | |
| Count at | 7.17 | 4.1 | 4.34 | 6.58 | 4.02 | 4.33 |
| 13 days Storage | | | | | | |
| 5 days retail | | | | | | |
| (Log CFU/g) | | | | | | |
| Count at | 6.33 | 1.27 | 1.87 | 5.03 | 1.25 | 2.04 |
| 20 days Storage | | | | | | |
| 0 days retail | | | | | | |
| (Log CFU/g) | | | | | | |
| Count at | 6.9 | 2.91 | 3.53 | 7.72 | 3.45 | 3.36 |
| 20 days Storage | | | | | | |
| 2 days retail | | | | | | |
| (Log CFU/g) | | | | | | |
| Count at | 8.2 | 6.61 | 6.17 | 8.07 | 6.55 | 6.14 |
| 20 days Storage | | | | | | |
| 5 days retail | | | | | | |
| (Log CFU/g) | | | | | | |
| Count at | — | 5.3 | 2.5 | — | 4.7 | 2.6 |
| 27 days Storage | | | | | | |
| 0 days retail | | | | | | |
| (Log CFU/g) | | | | | | |
| Count at | — | 6.3 | 4.3 | — | 6.2 | 4.1 |
| 27 days Storage | | | | | | |
| 2 days retail | | | | | | |
| (Log CFU/g) | | | | | | |
| Count at | — | 7.4 | 5.6 | — | 7.5 | 6 |
| 27 days Storage | | | | | | |
| 5 days retail | | | | | | |
| (Log CFU/g) | | | | | | |
| Count at | — | 2.7 | 6.9 | — | — | — |
| 34 days Storage | | | | | | |
| 0 days retail | | | | | | |
| (Log CFU/g) | | | | | | |
| Count at | — | 4.30 | 8 | — | — | — |
| 34 days Storage | | | | | | |
| 2 days retail | | | | | | |
| (Log CFU/g) | | | | | | |
| Count at | — | 7.80 | 8.1 | — | — | — |
| 34 days Storage | | | | | | |
| 5 days retail | | | | | | |
| (Log CFU/g) | | | | | | |

Microbial results from Table 6 show bacterial counts can be managed to an acceptable level (<Log 3 CFU/g) with the CO₂ master pouch through 27 days of cold storage, and even longer, up to 34 days, prior to retail display, yet as the fillet life was in excess of 27 days, the available retail display shelf life became shorter. T-VSP Comparative samples, held only in atmospheric air, were spoiled by 11 days total (5 days storage+6 days retail display) when microbial counts exceeded Log 6, which is the typical indicator of spoilage.

Salmon Test 2

In the following examples, the effects of permeability of the film used in the preparation of the individual packaged fillets on the appearance, odor, and pH of the packaged fillets was evaluated. Three sets of samples were prepared using Salmon Fillets 2. The first set of samples (4 K OTR Bags) were prepared as described above in which the fillets were vacuum skin packaged in bag comprised of a film having an OTR of 4,000 cc(STP)/m²/24 hrs/1 atm. In the second set of samples (VSP Bags) comprised of a film having an OTR of 10,000 cc(STP)/m²/24 hrs/1 atm as described previously. In the third set (17 K OTR Bags) were prepared as described above in which the fillets were vacuum skin packaged in bag comprised of a film having an OTR of 4,000 cc(STP)/m²/24 hrs/1 atm. The individual packaged fillets were placed in a master pouch, and then the atmosphere was modified to provide a sealed package comprised of a predominately CO₂ atmosphere. An oxygen absorber was added to each master pouch to decrease residual oxygen levels to 0.1% within 24 hours.

The master pouches containing the individually packaged fillets were then stored at temperatures from −1 to −1.5° C. to simulate cold storage, and then subjected to a slightly higher temperature profile at 1° C. to simulate distribution conditions, and then finally, placed in a retail display at a temperature ranging from 1 to 2.5° C. to simulate typical conditions of retail display at a grocery store. At various points during the cold storage, samples were removed to simulate distribution and retail display conditions. During this time, the fillets were evaluated the fillets for appearance (color), odor and microbial count.

In general, the values provided in Tables 7 through 8 are based on average sample counts ranging from 2 to 6 samples. The number of panelist conducting the subjective odor and color evaluations ranged between 3 and 4 panelists.

TABLE 7
Color and Odor Evaluation at 14 Days Cold Storage.

| | Average | Average | Average | Average | Average | Average | Average | Average |
|---|---|---|---|---|---|---|---|---|
| | Color | Color | Color | Color | Odor | Odor | Odor | Odor |
| | Scoring | Scoring | Scoring | Scoring | Scoring | Scoring | Scoring | Scoring |
| | 0 days | 4 days | 4 days | 4 days | 0 days | 4 days | 4 days | 4 days |
| | distri- | distri- | distri- | distri- | distri- | distri- | distri- | distri- |
| | bution | bution | bution | bution | bution | bution | bution | bution |
| | 0 days | 0 days | 3 days | 7 days | 0 days | 0 days | 3 days | 7 days |
| Sample | retail | retail | retail | retail | retail | retail | retail | retail |
| 4K | 1 | 1.56 | 1.44 | 1.67 | — | 1.88 | 2.00 | 1.83 |
| OTR | | | | | | | | |
| BAG | | | | | | | | |
| 10K | 1 | 1.4 | 1.34 | 1.50 | — | 1.50 | 2.00 | 1.67 |
| OTR | | | | | | | | |
| BAG | | | | | | | | |
| 17K | 1 | 1.38 | 1.38 | 1.33 | — | 1.56 | 2.00 | 1.33 |
| OTR | | | | | | | | |
| BAG | | | | | | | | |

Following 14 days of cold storage, minor differences were observed between salmon fillets within the three different film permeabilities, yet the 4 K OTR Bag samples were slightly inferior for color and odor by 14 days storage+4 days distribution (in modified atmosphere)+7 days retail display.

TABLE 8
Color and Odor Evaluation at 26 Days Cold Storage.

| | Average | Average | Average | Average | Average | Average | Average | Average |
|---|---|---|---|---|---|---|---|---|
| | Color | Color | Color | Color | Odor | Odor | Odor | Odor |
| | Scoring | Scoring | Scoring | Scoring | Scoring | Scoring | Scoring | Scoring |
| | 0 days | 4 days | 4 days | 4 days | 0 days | 4 days | 4 days | 4 days |
| | distri- | distri- | distri- | distri- | distri- | distri- | distri- | distri- |
| | bution | bution | bution | bution | bution | bution | bution | bution |
| | 0 days | 0 days | 3 days | 7 days | 0 days | 0 days | 3 days | 7 days |
| Sample | retail | retail | retail | retail | retail | retail | retail | retail |
| 4K | 1.67 | 1.75 | 2.69 | 3.67 | 1.83 | 2.20 | 2.10 | 3.50 |
| BAG | | | | | | | | |
| 10K | 1.50 | 1.54 | 2.50 | 3.0 | 1.67 | 1.70 | 2.10 | 2.08 |
| BAG | | | | | | | | |
| 17K | 1.33 | 1.38 | 2.25 | 3.0 | 1.33 | 1.40 | 2.00 | 2.83 |
| BAG | | | | | | | | |

After 26 days of cold storage+5 days of distribution temperature, the 4 K OTR Bag samples had an unacceptable color by day 7 of retail display, and also an unacceptable odor compared to the 10 K OTR and 17 K OTR Bag samples.

From the results provided in Tables 7 and 8 above, it is evident that the permeability of the film affects the freshness of the packaged fillets. In particular, following 26 days of storage, the individual fillets packaged in a bag comprised of the 10 k and 17 k OTR films exhibited improvements in both odor and color in comparison to the fillets packed in the 4 K OTR film. This improvement is believed to be a result of increased permeability in the film, which helps to facilitate permeation of CO₂ molecules from within the atmosphere of the master pouch through the permeable film. In general, the results provided in the tables also show that fillets packaged in 17 K OTR film exhibited improvements in odor and appearance over fillets packaged in 10 K OTR films. This demonstrates the importance of packaging the fillets in films having higher permeability to CO₂.

In Table 9, below, the aerobic microbial data for the samples of Tables 7 and 8 is provided.

TABLE 9
Aerobic Microbial Data

| | 4K BAG | 10K BAG | 17K BAG |
|---|---|---|---|
| Count at | 2.12 | 2.12 | 2.12 |
| 0 days Storage | | | |
| 0 days distribution | | | |
| 0 days retail | | | |
| (Log CFU/g) | | | |
| Count at | 2.94 | 2.98 | 2.91 |
| 14 days Storage | | | |
| 0 days distribution | | | |
| 0 days retail | | | |
| (Log CFU/g) | | | |
| Count at | 2.3 | 2.22 | 2.18 |
| 14 days Storage | | | |
| 4 days distribution | | | |
| 0 days retail | | | |
| (Log CFU/g) | | | |
| Count at | 4.01 | 4.28 | 4.1 |
| 14 days Storage | | | |
| 4 days distribution | | | |
| 3 days retail | | | |
| (Log CFU/g) | | | |
| Count at | 7.39 | 6.49 | 7.21 |
| 14 days Storage | | | |
| 4 days distribution | | | |
| 7 days retail | | | |
| (Log CFU/g) | | | |
| Count at | 3.03 | 2.78 | 2.75 |
| 26 days Storage | | | |
| 0 days distribution | | | |
| 0 days retail | | | |
| (Log CFU/g) | | | |
| Count at | 3.57 | 2.9 | 3.35 |
| 26 days Storage | | | |
| 5 days distribution | | | |
| 0 days retail | | | |
| (Log CFU/g) | | | |
| Count at | 7.9 | 5.34 | 5.72 |
| 26 days Storage | | | |
| 5 days distribution | | | |
| 3 days retail | | | |
| (Log CFU/g) | | | |
| Count at | 7.92 | 7.04 | 7.07 |
| 26 days Storage | | | |
| 5 days distribution | | | |
| 7 days retail | | | |
| (Log CFU/g) | | | |

From Table 9 above, it is evident that the permeability of the film to CO₂ also plays an important role in controlling microbial counts in the packaged fillets. Here, it can be seen that the packages comprising films having an OTR of 10 K and 17 K provided improvements in lower microbial counts in comparison to the packages comprised of the 4 K OTR film. In particular, the microbial counts of the samples following 26 days of storage, 5 days of distribution, and 3 days of retail display showed aerobic microbial counts below 6 Log CFU/g, which is within the limits of acceptability. Thus, it can be seen that these packages provided a shelf-life of at least 34 days. In contrast, the corresponding package comprising the 4 K OTR film exhibited an aerobic microbial count of 7.9 Log CFU/g, which is generally considered unacceptable.

In particular, the results of Tables 7 to 9 show the importance of permeability of the film in controlling microbial growth. In particular, salmon vacuum packaged in three varying levels of oxygen permeability films (4,000 vs 10,000 vs 17,000 OTR), within an oxygen barrier master pouch for 23 days gas flushed with 99.99% CO₂ gas held in refrigerated storage, showed a difference in microbial growth related to permeability of the film. Salmon fillets packaged within the 4,000 OTR film had higher microbial counts on average compared with fillets within 10,000 and 17,000 OTR films.

In summary, the Salmon Test 2 demonstrates that improvements in shelf-life are obtained by packaging the fillets in films having an OTR of at least 10,000 cc(STP)/m²/24 hrs/1 atm, and in combination with packaging the individual packages of fillets in a master pouch having a predominately CO₂ with a residual oxygen concentration of less than 0.1%.

Salmon Test 3

In Salmon Test 3, the procedures of Salmon Test 2 were substantially duplicated. However, a fourth set of samples also evaluated in which the salmon fillets were packaged in the BB Bag as described above. The samples were prepared using Salmon Fillets 3. As noted above, the BB bag comprised a film having an oxygen barrier layer that prevented ingress/egress of oxygen and CO₂ through the package.

As in the previous examples, the various samples were packaged and then stored at temperatures from −1 to −1.5° C. to simulate cold storage during transport. Following the allotted storage time, the samples were removed from cold storage and placed in a retail display at a temperature ranging from 1 to 2.5° C. to simulate typical conditions of retail display at a grocery store. For the retail display portion of the test, the samples (individual packages) were removed from the master pouch. At various points during the cold storage, samples were removed and then placed in the retail display to evaluate the fillets for color, odor and microbial count.

In general, the values provided in Tables 10 and 11 are based on average sample counts ranging from 2 to 6 samples. The number of panelist conducting the subjective odor and color reviews ranged between 3 and 4 panelists.

TABLE 10
Color and Odor Evaluation at 15 Days Cold Storage.

| | Average | Average | Average | Average | Average | Average | Average | Average |
|---|---|---|---|---|---|---|---|---|
| | Color | Color | Color | Color | Odor | Odor | Odor | Odor |
| | Scoring | Scoring | Scoring | Scoring | Scoring | Scoring | Scoring | Scoring |
| | 0 days | 4 days | 7 days | 11 days | 0 days | 4 days | 7 days | 11 days |
| Sample | retail | retail | retail | retail | retail | retail | retail | retail |
| 4K OTR | 1.64 | 1.60 | 1.38 | 2.9 | 1.81 | 1.88 | 1.5 | 2.0 |
| BAG | | | | | | | | |
| 10K OTR | 1.41 | 1.44 | 1.22 | 2.40 | 1.56 | 1.31 | 1.31 | 1.6 |
| BAG | | | | | | | | |
| 17K OTR | 1.44 | 1.50 | 1.47 | 2.50 | 1.50 | 1.56 | 1.63 | 2.2 |
| BAG | | | | | | | | |
| BB BAG | 1.22 | 1.15 | 2.13 | 5.10 | 1.13 | 1.38 | 2.31 | 3.9 |

The BB Bag samples resulted in significantly less acceptable color and odor after 11 days of retail display compared with all three permeable bags (4 K, 10 K, and 17 K) held in in a master pouch having a predominately CO₂ atmosphere prior to retail display.

TABLE 11
Color and Odor Evaluation at 23 Days Cold Storage.

| | Average | Average | Average | Average | Average | Average | Average | Average |
|---|---|---|---|---|---|---|---|---|
| | Color | Color | Color | Color | Odor | Odor | Odor | Odor |
| | Scoring | Scoring | Scoring | Scoring | Scoring | Scoring | Scoring | Scoring |
| | 0 days | 4 days | 7 days | 11 days | 0 days | 4 days | 7 days | 11 days |
| Sample | retail | retail | retail | retail | retail | retail | retail | retail |
| 4K OTR | 1.81 | 3.23 | 3.40 | 4.3 | 1.63 | 2.13 | 2.40 | 2.95 |
| BAG | | | | | | | | |
| 10K OTR | 1.53 | 2.44 | 2.68 | 3.3 | 1.13 | 2.00 | 1.80 | 2.70 |
| BAG | | | | | | | | |
| 17K OTR | 1.38 | 2.56 | 3.30 | 4.2 | 1.69 | 1.88 | 2.10 | 3.50 |
| BAG | | | | | | | | |
| BB BAG | 1.09 | 1.63 | 2.85 | 3.1 | 1.00 | 3.25 | 3.60 | 3.95 |

The results in Tables 10 and 11 further emphasize the importance of the permeability of the film used in vacuum packaging the fillets. In particular, at 7 days of retail display the packages comprising the 10 K and 17 K OTR films exhibited significantly improved odor scores in comparison to the BB Bag and the 4 K OTR Bag. This test provided a comparison of the CO₂ master pouch comparative to fillets vacuum packaged within an oxygen barrier shrink bag without any treatment gas. Microbial quality within the barrier shrink bag without any CO₂ gas was inferior at the end of 23 days refrigerated storage compared to all of the oxygen permeable/CO₂ permeable films within the master pouch with high CO₂ treatment gas. This demonstrates the value of a high CO₂ gas level coupled with the ability of the CO₂ gas to permeate through a package with 10,000 OTR or higher OTR.

In Table 12, below, the aerobic microbial data for the samples of Tables 10 and 11 is provided.

TABLE 12
Aerobic Microbial Data

| | 4K OTR | 10K OTR | 17K OTR | BB OTR |
|---|---|---|---|---|
| | BAG | BAG | BAG | BAG |
| Count at | 2.04 | 2.04 | 2.04 | 2.04 |
| 0 days Storage | | | | |
| 0 days distribution | | | | |
| 0 days retail | | | | |
| (Log CFU/g) | | | | |
| Count at | 0 | 0 | 0.15 | 1.93 |
| 15 days Storage | | | | |
| 0 days retail | | | | |
| (Log CFU/g) | | | | |
| Count at | 2.20 | 5.72 | 4.59 | 6.05 |
| 15 days Storage | | | | |
| 4 days retail | | | | |
| (Log CFU/g) | | | | |
| Count at | 3.90 | 5.72 | 4.59 | 7.7 |
| 15 days Storage | | | | |
| 7 days retail | | | | |
| (Log CFU/g) | | | | |
| Count at | 5.87 | 6.62 | 7.64 | 8.38 |
| 15 days Storage | | | | |
| 11 days retail | | | | |
| (Log CFU/g) | | | | |
| Count at | 1.8 | 1.15 | 1.54 | 5.13 |
| 23 days Storage | | | | |
| 0 days retail | | | | |
| (Log CFU/g) | | | | |
| Count at | 3.98 | 2.13 | 1.39 | 8.01 |
| 23 days Storage | | | | |
| 4 days retail | | | | |
| (Log CFU/g) | | | | |
| Count at | 5.42 | 4.23 | 4.57 | 9.13 |
| 23 days Storage | | | | |
| 7 days retail | | | | |
| (Log CFU/g) | | | | |
| Count at | 7.66 | 7.80 | 7.71 | 8.93 |
| 26 days Storage | | | | |
| 10 days retail | | | | |
| (Log CFU/g) | | | | |

The microbial data provided in Table 12 above, demonstrates the importance of permeability of the film with respect to inhibiting microbial growth. In particular, the results following 23 days storage clearly show a significant reduction for the oxygen permeable films (OTR of at least 10 K) in comparison to the vacuumized BB Bag without CO₂, which includes an oxygen barrier layer. This demonstrates the value of a high CO₂ gas level coupled with the ability of the CO₂ gas to permeate through a package with 10,000 OTR or higher OTR.

The pH of the muscle tissue of samples stored at 23 days of cold storage were also evaluated. The results are provided in Table 13 below. Initial pH of salmon fillets prior to packaging averaged 6.3. The pH was an average based on an average of two measurements of the pH of the fillet's muscle tissue.

TABLE 13
pH of Fillets at 23 days cold storage

| Sample Description | Average pH |
|---|---|
| 4K OTR BAG | 6.27 |
| 10K OTR BAG | 6.04 |
| 17K OTR BAG | 6.0 |
| BB BAG | 6.21 |

In general, it can be seen that the samples using the higher OTR films (e.g., 10 k and 17 K OTR) have a lower pH in comparison to the 4 K OTR bag and the BB Bag. This lower pH is indicative of a higher level of CO₂ gas permeating through the film and contacting the tissue of the fillets. As explained previously, it is believed that the interaction of CO₂ with the surface of the fillet forms carbonic acid, which acts as a bactericide to inhibit the growth of bacteria. Data from the salmon fillets stored for 23 days revealed a pH gradient as a result of OTR film, which is correlated to CO₂ permeability. This data demonstrates a packaging film of at least 10,000 OTR or higher is ideal for CO₂ permeability and affect upon pH of the fish fillet and reduction or control of spoilage bacterial growth during modified atmosphere storage, prior to retail display when removed from the master pouch. Salmon fillets packaged within the oxygen barrier shrink bag without the benefit of CO₂ gas resulted in a higher pH compared to the fillets within 10,000 or higher OTR films held within the high CO₂ master pouch. The pH decline of fillets within the barrier shrink bag vacuum package is attributed to growth of lactic acid bacteria.

Salmon Test 4

In Salmon Test 4, whole salmon was packed in a 10 K bag as described above. Two whole salmon were used for each sample and results are averaged over the two. Control 4 was then placed into a BB Bag without modifying the internal atmosphere of the BB Bag. Salmon 4 was then placed into a BB Bag as described above and gas flushed with 100% CO₂. The residual oxygen measured 0.10% and CO₂ measured 99.8%. As noted above, the BB bag comprised a film having an oxygen barrier layer that prevented ingress/egress of oxygen and CO₂ through the package.

Both samples were stored at temperatures from −1 to −1.5° C. to simulate cold storage during transport for 8 days. Following the allotted storage time, the samples were removed from cold storage and placed in a retail display at a temperature ranging from 1 to 2.5° C. to simulate typical conditions of retail display at a grocery store. For the retail display portion of the test, the samples (individual packages) were removed from the BB Bag. At various points during the cold storage, samples were removed and then placed in the retail display to evaluate the fillets for color and microbial count.

| | Aerobic | Aerobic |
|---|---|---|
| | Microbial | Microbial |
| | Data | Data |
| | Count at | Count at |
| | 0 days | 12 days |
| | Storage | Storage |
| | 0 days retail | 0 days retail |
| Sample | (Log CFU/g) | (Log CFU/g) |
| Control 4 | 1.59 | 5.81 |
| Salmon 4 | 2.51 | 3.63 |

The above data shows that the package having the modified CO₂ atmosphere resulted in lower aerobic microbial counts. Salmon 4 had significantly lower aerobic counts while Control 4 increased over the same time period.

| | | | | Average |
|---|---|---|---|---|
| | Average | Average | Average | Hunter |
| | Hunter | Hunter | Hunter | Lab Score |
| | Lab Score (L) | Lab Score (a) | Lab Score (b) | (L + b)/a |
| | 0 Days retail; | 0 Days retail; | 0 Days retail; | 0 Days retail; |
| Sample No. | 3 Days retail | 3 Days retail | 3 Days retail | 3 Days retail |
| Control 4 | 53.30; | 25.46; | 25.61; | 3.10; |
| | 54.28 | 25.15 | 24.86 | 3.15 |
| Salmon 4 | 49.33; | 26.64; | 25.18; | 2.80; |
| | 50.67 | 26.09 | 24.79 | 2.89 |

The above data shows that the package having the modified CO₂ atmosphere resulted in improved color in the whole salmon.

Tilapia Test 1

The experimental conditions for Tilapia Test 1 were substantially similar to those described above for Salmon Test 1. As in Salmon Test 1, the effects of packaging tilapia fillets in individual, CO₂ permeable packages, which were then packaged in master pouch having a CO₂ modified atmosphere was evaluated for appearance, odor, and microbial count in comparison to fillets package only in the permeable packages, and fillets packaged in a modified atmosphere without individual packaging of each fillet.

In Tilapia Test 1, three sets of samples were prepared using Tilapia Fillets 1. The first set of samples (identified in the tables below as VSP Comparative) were prepared in which the fillets were thermoformed-vacuum skin packaged as described above with no master pouch and no modified atmosphere. In the second set of samples (identified in the tables below as Naked Comparative), naked fillets were packaged in a master pouch having a modified atmosphere comprised predominately of CO₂. An oxygen absorber was added to the master pouch to decrease residual oxygen levels to 0.1% within 24 hours. In the third set of samples (identified in the tables below as VSP+MP) the fillets were thermoformed-vacuum skin packaged as described above, and then packaged into a master pouch having a modified atmosphere comprised predominately of CO₂. An oxygen absorber was added to the master pouch to decrease residual oxygen levels to 0.1% within 24 hours.

The various samples were then stored at temperatures from −1 to −1.5° C. to simulate cold storage during transport for up to 34 days, and then placed in a retail display at a temperature ranging from 1 to 2.5° C. to simulate typical conditions of retail display at a grocery store. For samples packaged in a master pouch, the samples were removed from the master pouch for the retail display portion of the evaluation. At various points during the cold storage, samples were removed and then placed in the retail display to evaluate the fillets for color, odor and microbial count.

In general, the values provided in Tables 14 through 18 are based on average sample counts ranging from 2 to 6 samples. The number of panelist conducting the subjective odor and color reviews ranged between 3 and 4 panelists.

TABLE 14
Color and Odor Evaluation at 6 Days Cold Storage.

| | Average | Average | Average | Average | Average | Average |
|---|---|---|---|---|---|---|
| | Color | Color | Color | Odor | Odor | Odor |
| | Scoring | Scoring | Scoring | Score | Score at | Score at |
| Sample | at 0 days | at 3 days | at 6 days | at 0 days | 3 days | 7 days |
| No. | retail | retail | retail | retail | retail | retail |
| VSP | 1.1 | 1.4 | 2.3 | 1.0 | 1.3 | 2.7 |
| Tilapia | | | | | | |
| Com- | | | | | | |
| parative | | | | | | |
| Sample 1 | | | | | | |
| Naked | 1.3 | 1.3 | 1.8 | 1.0 | 1.2 | 2.2 |
| Tilapia | | | | | | |
| Com- | | | | | | |
| parative | | | | | | |
| Sample 1 | | | | | | |
| VSP + MP | 1.4 | 1.4 | 1.9 | 1.1 | 1.4 | 2.1 |
| Tilapia | | | | | | |
| Sample 1 | | | | | | |

In general, all samples were within acceptability for color through 6 days of retail display, following 6 days of cold storage, yet VSP Comparative samples had unacceptable odor by day 7 of retail display, while Naked Comparative and VSP+MP samples stored in a predominately CO₂ prior to retail display exhibited acceptable color and odor.

TABLE 15
Color and Odor Evaluation at 14 Days Cold Storage.

| | Average | Average | Average | Average | Average | Average |
|---|---|---|---|---|---|---|
| | Color | Color | Color | Odor | Odor | Odor |
| | Scoring | Scoring | Scoring | Score at | Score at | Score at |
| Sample | at 0 days | at 2 days | at 6 days | 0 days | 2 days | 6 days |
| No. | retail | retail | retail | retail | retail | retail |
| VSP Tilapia | 1.3 | 2.2 | 2.8 | 1.0 | 1.9 | 2.6 |
| Comparative | | | | | | |
| Sample 1 | | | | | | |
| Naked Tilapia | 1.2 | 1.5 | 2.1 | 1.0 | 1.5 | 1.3 |
| Comparative | | | | | | |
| Sample 1 | | | | | | |
| VSP + MP | 1.3 | 2.3 | 2.2 | 1.3 | 1.9 | 2.0 |
| Tilapia | | | | | | |
| Sample 1 | | | | | | |

Following 14 days of cold storage, the VSP Comparative samples stored only in atmospheric air had both unacceptable color and odor at 6 days of retail display. In contrast, the Naked Comparative and VSP+MP samples stored in a predominately CO₂ atmosphere exhibited acceptable color and odor.

TABLE 16
Color and Odor Evaluation at 21 Days Cold Storage.

| | Average | Average | Average | Average | Average | Average |
|---|---|---|---|---|---|---|
| | Color | Color | Color | Odor | Odor | Odor |
| | Scoring | Scoring | Scoring | Score at | Score at | Score at |
| | at 0 days | at 2 days | at 6 days | 0 days | 2 days | 6 days |
| Sample No. | retail | retail | retail | retail | retail | retail |
| VSP Tilapia | 1.3 | 2.4 | 3.8 | 1.0 | 2.3 | 4.0 |
| Comparative | | | | | | |
| Sample 1 | | | | | | |
| Naked Tilapia | 1.0 | 1.1 | 1.9 | 1.1 | 1.0 | 1.8 |
| Comparative | | | | | | |
| Sample 1 | | | | | | |
| VSP + MP | 1.0 | 1.2 | 1.9 | 1.3 | 1.3 | 2.2 |
| Tilapia | | | | | | |
| Sample 1 | | | | | | |

By day 21 of cold storage and day 2 of retail display, the VSP Comparative samples were near the line of unacceptability for color and odor, and by day 6 of retail display were extremely unacceptable. However, the Naked Comparative samples and the VSP+MP samples stored in a predominately CO₂ atmosphere exhibited acceptable color and odor after 6 days of retail display.

TABLE 17
Color and Odor Evaluation at 28 Days Cold Storage.

| | Average | Average | Average | Average | Average | Average |
|---|---|---|---|---|---|---|
| | Color | Color | Color | Odor | Odor | Odor |
| | Scoring | Scoring | Scoring | Score at | Score at | Score at |
| | at 0 days | at 2 days | at 6 days | 0 clays | 2 days | 6 days |
| Sample No. | retail | retail | retail | retail | retail | retail |
| VSP Tilapia | — | — | — | — | — | — |
| Comparative | | | | | | |
| Sample 1 | | | | | | |
| Naked Tilapia | 1.1 | 1.5 | 2.5 | 1.3 | 1.2 | 2.2 |
| Comparative | | | | | | |
| Sample 1 | | | | | | |
| VSP + MP | 1.4 | 2.0 | 3.0 | 2.3 | 2.0 | 3.1 |
| Tilapia | | | | | | |
| Sample 1 | | | | | | |

The VSP Comparative samples were removed from testing by day 28 of cold storage due to unacceptability, while Naked Comparative and VSP+MP samples were still acceptable through 2 days of retail display and marginal or expired by day 6 of retail display.

TABLE 18
Color and Odor Evaluation at 34 Days Cold Storage.

| | Average | Average | Average | Average | Average | Average |
|---|---|---|---|---|---|---|
| | Color | Color | Color | Odor | Odor | Odor |
| | Scoring | Scoring | Scoring | Score at | Score at | Score at |
| | at 0 days | at 2 days | at 5 days | 0 days | 2 days | 5 days |
| Sample No. | retail | retail | retail | retail | retail | retail |
| VSP Tilapia | — | — | — | — | — | — |
| Comparative | | | | | | |
| Sample 1 | | | | | | |
| Naked Tilapia | — | — | — | — | — | — |
| Comparative | | | | | | |
| Sample 1* | | | | | | |
| VSP + MP | 1.2 | 1.3 | 3.3 | 2.0 | 3.6 | 2.9 |
| Tilapia | | | | | | |
| Sample 1 | | | | | | |

*Day 34 results unavailable due to leakage of master pouch

The Naked Comparative samples could not be included in day 34 cold storage data due to leakage of the master pouch, and extremely high oxygen level within the pouch (>14% oxygen). The data for the VSP+MP samples removed from a master pouch with less than 0.1% residual oxygen showed acceptable color for the first 48 hours of display, yet unacceptable by day 5 of retail display. Once again, a storage period of greater than 30 days resulted in a short retail shelf-life of fillets in the >10 K OTR film following removal of samples from the CO₂ master pouch at which time the packaged fillets were exposed to atmospheric air.

TABLE 19
Microbial Data for the Samples of Tables 14-18

| | Aerobic | | | Anaerobic | | |
|---|---|---|---|---|---|---|
| | Microbial Data | | | Microbial Results | | |
| | Tilapia | Naked | | Tilapia | Naked | |
| | VSP | Tilapia | Tilapia | VSP | Tilapia | Tilapia |
| | Com- | Com- | VSP + | Com | Com | VSP + |
| | parative | parative | MP | parative | parative | MP |
| Count at | | | | | | |
| 0 days Storage | | | | | | |
| 0 days retail | | | | | | |
| (Log CFU/g) | | | | | | |
| Count at | 2.34 | 2.22 | 2.19 | 1.94 | 0.73 | 1.69 |
| 6 days Storage | | | | | | |
| 0 days retail | | | | | | |
| (Log CFU/g) | | | | | | |
| Count at | 4.47 | 3.10 | 2.97 | 3.87 | 2.80 | 3.14 |
| 6 days Storage | | | | | | |
| 3 days retail | | | | | | |
| (Log CFU/g) | | | | | | |
| Count at | 7.47 | 6.69 | 7.45 | 6.63 | 5.34 | 5.68 |
| 6 days Storage | | | | | | |
| 7days retail | | | | | | |
| (Log CFU/g) | | | | | | |
| Count at | 3.67 | 1.69 | 2.25 | 2.65 | 1.15 | 1.39 |
| 14 days Storage | | | | | | |
| 0 days retail | | | | | | |
| (Log CFU/g) | | | | | | |
| Count at | 5.70 | 3.22 | 2.48 | 5.50 | 1.59 | 2.51 |
| 14 days Storage | | | | | | |
| 2 days retail | | | | | | |
| (Log CFU/g) | | | | | | |
| Count at | 7.17 | 5.19 | 4.98 | 6.52 | 3.94 | 3.55 |
| 14 days Storage | | | | | | |
| 6 days retail | | | | | | |
| (Log CFU/g) | | | | | | |
| Count at | 6.36 | 1.73 | 1.85 | — | — | — |
| 21 days Storage | | | | | | |
| 0 days retail | | | | | | |
| (Log CFU/g) | | | | | | |
| Count at | 7.16 | 1.74 | 2.40 | — | — | — |
| 21 days Storage | | | | | | |
| 2 days retail | | | | | | |
| (Log CFU/g) | | | | | | |
| Count at | 7.58 | 4.90 | 5.27 | — | — | — |
| 21 days Storage | | | | | | |
| 6 days retail | | | | | | |
| (Log CFU/g) | | | | | | |
| Count at | — | 1.82 | 1.97 | — | — | — |
| 28 days Storage | | | | | | |
| 0 days retail | | | | | | |
| (Log CFU/g) | | | | | | |
| Count at | — | 2.28 | 2.25 | — | — | — |
| 28 days Storage | | | | | | |
| 2 days retail | | | | | | |
| (Log CFU/g) | | | | | | |
| Count at | — | 2.86 | 2.88 | — | — | — |
| 28 days Storage | | | | | | |
| 6 days retail | | | | | | |
| (Log CFU/g) | | | | | | |
| Count at | — | — | 0.95 | — | — | — |
| 34 days Storage | | | | | | |
| 0 days retail | | | | | | |
| (Log CFU/g)* | | | | | | |
| Count at | — | — | — | — | — | — |
| 34 days Storage | | | | | | |
| 2 days retail | | | | | | |
| (Log CFU/g) | | | | | | |
| Count at | — | — | 6.37 | — | — | — |
| 34 days Storage | | | | | | |
| 7 days retail | | | | | | |
| (Log CFU/g) | | | | | | |

Anaerobic Microbial Data measurement was discontinued following 14 days storage due to substantially duplicative results of the aerobic microbial count.
*Day 34 results unavailable due to leakage of master pouch

Microbial data from Table 19 reveals that the VSP Comparative samples stored in atmospheric air were >Log 6 in less than 13 days from the first group, and spoiled within 20 days from the second and third storage groups. However, the microbial counts for the Naked Comparative and VS+MP samples, which were held in CO₂ master pouches prior to retail display for 28 days cold storage exhibited a total of 34 days of shelf-life (28 days cold storage +6 days retail display).

Tilapia Test 2

In following examples, the effects of residual oxygen in the sealed master pouch on the quality of packaged tilapia fillets was evaluated. Six sets of samples were prepared with the Tilapia Fillets 2. In these examples, various samples were prepared in which the master pouch included a residual oxygen concentration from 0.01 to approximately 2% by volume. Samples comprising the thermoformed vacuum skin packaging (T-VSP), and the vacuum shrink bag (VSB) were prepared in accordance with the materials and procedures described previously. Groups of six of the individually packed tilapia fillets were introduced into the master pouch. The master pouched was then flushed with a modified atmosphere to produce a predominately carbon dioxide atmosphere in the master pouch. The sealed pouches were then placed in cold storage at a temperature of about −1 to −1.5° C. for a period of 20 days to simulate transport. At the allotted time, the individual packages were removed from the master pouch and placed in a chilled retail display. The packages were evaluated at +0 days retail, +3 days retail, +7 days retail, and +10 days retail for color, odor and aerobic microbial count.

In general, the values provided in Tables 20 and 21 are based on average sample counts ranging from 2 to 6 samples. The number of panelist conducting the subjective odor and color reviews ranged between 3 and 4 panelists.

TABLE 20
Evaluation of the Effects of Residual Oxygen on Color and Odor of Tilapia Fillets

| | Average | Average | Average | Average | Average | Average | Average | Average |
|---|---|---|---|---|---|---|---|---|
| | Color | Color | Color | Color | Odor | Odor | Odor | Odor |
| | Scoring | Scoring | Scoring | Scoring | Score at | Score | Score at | Score at |
| Sample | at 0 days | at 3 days | at 7 days | at 10 days | 0 days | at 3 days | 7 days | 10 days |
| No. | retail | retail | retail | retail | retail | retail*² | retail | retail |
| T-VSP | 2.5 | 2.1 | 2.4 | 3.3 | 2.5 | 2.1 | 2.4 | 3.3 |
| 2% | | | | | | | | |
| residual | | | | | | | | |
| Oxygen | | | | | | | | |
| VSB | 2.3 | 2.4 | 2.7 | 3.7 | 2.3 | 2.4 | 2.7 | 3.7 |
| 2% | | | | | | | | |
| residual | | | | | | | | |
| oxygen | | | | | | | | |
| T-VSP | 1.6 | 1.8 | 1.9 | 2.4 | 1.6 | 1.8 | 1.9 | 2.4 |
| 0.1% | | | | | | | | |
| residual | | | | | | | | |
| oxygen | | | | | | | | |
| VSB | 1.8 | 1.9 | 2.2 | 3.3 | 1.8 | 1.9 | 2.2 | 3.3 |
| 0.1% | | | | | | | | |
| residual | | | | | | | | |
| oxygen | | | | | | | | |
| T-VSP | 1.5 | 1.7 | 2.1 | 2.9 | 1.5 | 1.7 | 2.1 | 2.9 |
| 0.01% | | | | | | | | |
| residual | | | | | | | | |
| oxygen | | | | | | | | |
| VSB | 1.7 | 1.7 | 2.1 | 2.1 | 1.7 | 1.7 | 2.1 | 2.1 |
| 0.01% | | | | | | | | |
| residual | | | | | | | | |
| oxygen | | | | | | | | |

As can be seen in Table 20, maintaining a residual oxygen concentration below 0.1% in the master pouch helps to improve the appearance (e.g., color) during retail display. In particular, oxygen concentrations of about 2% oxygen failed the subjective color test following about day 5 or 6 of retail display. It can also be seen that the appearance of the samples having a 2.5% subjective score were already approaching marginal acceptability. In this regard, FIG. 4 graphically shows an average score of the T-VSP and VSB packages at days 0, 3, 7, and 11. FIG. 4 shows that the individual packages that were packaged in a master pouch having a residual oxygen content of 0.1% or less provided improvements in appearance, and hence extended shelf-life, in comparison to master pouches having higher residual oxygen concentrations. Significantly, this improvement resulted in a longer available time for retail display of the packaged fillets following removal of the packages from the master pouch.

TABLE 21
Evaluation of the Effects of Residual
Oxygen on Hunter Lab Color of Tilapia Fillets

| | Average Hunter | Average Hunter | Average Hunter |
|---|---|---|---|
| | Lab Score (L) | Lab Score (a) | Lab Score (b) |
| | 0 Days retail; | 0 Days retail; | 0 Days retail; |
| | 3 Days retail; | 3 Days retail; | 3 Days retail; |
| | 7 Days retail; and | 7 Days retail; and | 7 Days retail; and |
| Sample No. | 10 Days retail | 10 Days retail | 10 Days retail |
| T-VSP | 59.94 | 0.94 | 10.35 |
| 2% residual | 59.49; | −0.49; | 9.38; |
| Oxygen | 60.11; | −1.33; | 9.16; |
| | 61.36 | −1.97 | 8.80 |
| VSB | 61.91; | 0.71; | 9.72; |
| 2% residual | 62.08; | −0.47; | 8.87; |
| oxygen | 64.32; | −0.95; | 8.73; |
| | 66.23 | −1.70 | 9.15 |
| T-VSP | 60.11; | 1.38; | 9.47; |
| 0.1% residual | 59.15; | 0.40; | 9.21; |
| oxygen | 60.05; | 0.06; | 8.96; |
| | 61.84 | 0.03 | 9.24 |
| VSB | 63.22; | 0.90; | 9.54; |
| 0.1% residual | 62.02; | 0.40; | 8.82; |
| oxygen | 62.00; | −0.54; | 8.60; |
| | 62.02 | −1.52 | 8.86 |
| T-VSP | 60.43; | 1.45; | 9.97; |
| 0.01% residual | 59.49; | 0.93; | 8.82; |
| oxygen | 60.11; | 0.16; | 8.87; |
| | 61.17 | −0.87 | 8.90 |
| VSB | 62.22; | 1.29; | 9.41; |
| 0.01% residual | 60.13; | 1.08; | 8.26; |
| oxygen | 59.80; | 0.37; | 8.57; |
| | 59.97 | −0.71 | 8.68 |

A Hunter “a” value of less than −0.5 is correlated with unacceptable tilapia fillet subjective color score of 2.5 or greater. This indicates that all the 2% residual oxygen samples were borderline unacceptable by day 3 of retail display, and definitely unacceptable by day 7 of retail display. In contrast, the samples packaged in atmosphere having less than 0.1% residual oxygen exhibited acceptable color during the same time period as evidenced by the “a” values.

TABLE 22
Evaluation of the Effects of Residual
Oxygen on microbial Counts Fillets

| | Aerobic | Aerobic | Aerobic | Aerobic |
|---|---|---|---|---|
| | Bacterial | Bacterial | Bacterial | Bacterial |
| | Counts | Counts | Counts | Counts |
| | 0 Days | 3 Days | 7 Days | 10 Days |
| | Retail | Retail | Retail | Retail |
| Sample No. | (CFU/g) | (CFU/g) | (CFU/g) | (CFU/g) |
| T-VSP | 2.36 | 3.01 | 5.48 | 7.69 |
| 2% residual Oxygen | | | | |
| VSB | 2.62 | 3.48 | 5.2 | 7.93 |
| 2% residual oxygen | | | | |
| T-VSP | 2.37 | 3.24 | 5.53 | 7.98 |
| 0.1% residual oxygen | | | | |
| VSB | 2.48 | 2.99 | 5.56 | 7.8 |
| 0.1% residual oxygen | | | | |
| T-VSP | 2.52 | 4.87 | 5.59 | 7.88 |
| 0.01% residual oxygen | | | | |
| VSB | 3.53 | 4.64 | 6.3 | 7.97 |
| 0.01% residual | | | | |
| oxygen | | | | |

Results of the residual oxygen testing demonstrates the importance of residual oxygen level of 0.1% or less upon color and odor (Tables 20 and 21), which are the primary indicators of shelf-life for both retail supermarket employees and purchasing consumers. Microbial data (Table 22) shows the value of a high percentage of CO₂ upon controlling spoilage bacteria (total aerobic counts) within the gas flushed master pouch at the beginning of retail display (day 0 retail) after 20 days of cold storage as all treatments were well below indication of spoilage level of Log 6 to 7 CFU/g.

Many modifications and other embodiments of the invention set forth herein will come to mind to one skilled in the art to which the invention pertains having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A system for packaging a fresh food product, the system comprising:
a plurality of packages having a fresh food product sealed therein, the packages comprising an oxygen permeable film, the oxygen permeable film having an oxygen transmission rate (OTR) of at least 10,000 cc(STP)/m²/day/1 atm at 23° C. and 0% relative humidity (RH) as measured in accordance with ASTM D3985;
a master pouch having an interior space in which the plurality of packages are enclosed, the master pouch comprised of a film having an oxygen barrier layer such that the OTR of the film of the master pouch is less than 20 cc(STP)/m²/day/1 atm at 23° C. and 0% RH as measured in accordance with ASTM D3985; and
a modified atmosphere in the interior space of the master pouch comprising carbon dioxide and having an oxygen concentration that is less than 0.1% by volume.

2. The system for packaging a fresh food product according to claim 1, wherein the fresh food product comprises fish.

3. The system for packaging a fresh food product according to claim 1, further comprising an oxygen scavenging composition in fluid communication with the modified atmosphere of the master pouch.

4. (canceled)

5. (canceled)

6. The system for packaging a fresh food product according to claim 1, wherein the modified atmosphere comprises nitrogen gas, carbon dioxide gas, or mixtures thereof.

7. The system for packaging a fresh food product according to claim 1, wherein a time temperature indicator is disposed in the interior space of the master pouch.

8. The system for packaging a fresh food product according to claim 1, wherein the oxygen permeable film has an OTR of at least 20,000 cc(STP)/m²/day/1 atm at 23° C. and 0% RH.

9. (canceled)

10. (canceled)

11. The system for packaging a fresh food product according to claim 1, wherein the fresh food product, when stored at a temperature of −1.5° C. to 1° C. has a total shelf life of at least 28 days.

12. (canceled)

13. The system for packaging a fresh food product according to claim 1, wherein the oxygen permeable film is not perforated.

14. The system for packaging a fresh food product according to claim 1, wherein the modified atmosphere in the interior space of the master pouch comprises at least 99.5% by volume carbon dioxide.

15. (canceled)

16. The system for packaging a fresh food product according to claim 1, wherein the modified atmosphere in the interior space of the master pouch comprises less than 0.4% by volume carbon monoxide.

17. The system for packaging a fresh food product according to claim 1, wherein the oxygen permeable film is a multilayer film comprising
a. a sealant layer comprising a polymer blend comprising up to 98% by weight of linear low density polyethylene/hexene copolymer;
b. a core layer comprising a very low density polyethylene/octene copolymer; and
c. an outer abuse layer comprising a blend of high density polyethylene 98% by weight, and low density polyethylene with silica.

18. (canceled)

19. (canceled)

20. The system for packaging a fresh food product according to claim 17 wherein the sealant layer, the outer abuse layer or both the sealant layer and the outer abuse layer further comprises between 1-10% low density polyethylene blended with silica.

21. (canceled)

22. (canceled)

23. (canceled)

24. The system for packaging a fresh food product according to claim 17 wherein the blend of the outer abuse layer comprises up to 95% by weight of high density polyethylene.

25. The system for packaging a fresh food product according to claim 1, wherein at least one of the plurality of packages comprises a bottom film web.

26. The system for packaging a fresh food product according to claim 25 wherein the bottom film web is a thermoformed tray.

27. The system for packaging a fresh food product according to claim 26 wherein the thermoformed tray has an OTR of at least 10,000 cc(STP)/m²/day/1 atm at 23° C. and 0% RH as measured in accordance with ASTM D3985.

28. The system for packaging a fresh food product according to claim 25 wherein the bottom film web comprises:
a. a first layer comprising a blend of ethylene vinyl acetate and polybutylene;
b. a second layer comprising a linear low density polyethylene;
c. a third layer comprising a linear low density polyethylene;
d. a fourth layer comprising an ethylene vinyl alcohol;
e. a fifth comprising a linear low density polyethylene;
f. a sixth layer comprising a blend of blend of linear low density polyethylene and low density polyethylene; and
g. a seventh layer comprising a semi-rigid PVC.

29. (canceled)

30. The system for packaging a fresh food product according to claim 1 wherein the master pouch is made from a multilayer film.

31. The system for packaging a fresh food product according to claim 30 wherein the multilayer film of the master pouch is an oriented film.

32. (canceled)

33. (canceled)

34. The system for packaging a fresh food product according to claim 30 wherein the multilayer film of the master pouch comprises:
a. a sealant layer comprising a blend very low density polyethylene/octene copolymer and a linear low density polyethylene;
b. a core layer comprising an ethylene/butyl acrylate copolymer; and
c. an outer layer comprising a blend of a very low density polyethylene, a low density polyethylene/octene copolymer and a blend of a fluoropolymer blended in linear low density polyethylene.

35. The system for packaging a fresh food product according to claim 34 wherein the sealant layer of the multilayer film of the master pouch comprises a blend of 60-90%, by weight of very low density polyethylene/octene copolymer and 10-40%, by weight of a linear low density polyethylene.

36. (canceled)

37. The system for packaging a fresh food product according to claim 34 wherein the outer layer of the multilayer film of the master pouch comprises a blend of 75-95% by weight of a very low density polyethylene, 10-20% by weight of a low density polyethylene/octene copolymer and a blend of a 0.1-2.0% by weight of a fluoropolymer blended in linear low density polyethylene.

38. The system for packaging a fresh food product according to claim 30 wherein the multilayer film of the master pouch comprises:
a. a first layer comprising a blend of medium density polyethylene, ethylene vinyl acetate, and an ethylene copolymer;
b. a second layer comprising a linear low density polyethylene;
c. a third layer comprising a blend of linear low density polyethylene and medium density polyethylene; and
d. a fourth layer comprising a blend of medium density polyethylene, ethylene vinyl acetate, and an ethylene copolymer.

39. The system for packaging a fresh food product according to claim 30 wherein the multilayer film of the master pouch has an OTR of at least 17,000 cc(STP)/m²/day/1 atm at 23° C. at 0% relative humidity RH as measured in accordance with ASTM D3985.

40. The system for packaging a fresh food product according to claim 30 wherein the multilayer film of the master pouch comprises:
a. a first layer which is a sealant layer comprising a linear low density polyethylene, a very low density polyethylene or blends thereof;
b. a second layer comprising a low density polyethylene
c. a third layer comprising an oxygen barrier layer;
d. a fourth layer comprising a linear low density polyethylene, a low density polyethylene or bends thereof; and
e. a fifth layer comprising a low density polyethylene.

41. The system for packaging a fresh food product according to claim 40 wherein the third layer of the multilayer film of the master pouch comprises polyvinylidene chloride methyl acrylate.

42. A method of packaging a fresh food product comprising:
sealing a fresh food product within a package, the package comprising an oxygen permeable film having an OTR of at least 10,000 cc(STP)/m²/day/1 atm at 23° C. at 0% relative humidity RH as measured in accordance with ASTM D3985;
introducing a plurality of sealed packages within a master pouch, the master pouch comprising a film having an oxygen barrier layer such that the OTR of the film of the master pouch is less than 20 cc(STP)/m²/day/1 atm at 23° C. at 0% RH as measured in accordance with ASTM 3985, the master pouch having an interior space;
introducing a modified atmosphere into the interior space of the master pouch, the modified atmosphere predominately comprising carbon dioxide;
sealing the master pouch to enclose the plurality of the sealed packages therein; and
reducing residual oxygen concentration in the interior space of the master pouch to 0.1% or less by volume within 24 hours of sealing the master pouch.

43. (canceled)

44. (canceled)

45. (canceled)

46. (canceled)

47. (canceled)

48. (canceled)

49. (canceled)

50. (canceled)

51. A packaged fresh food product comprising:
a plurality of packages having a fresh food product sealed therein, the packages comprising an oxygen permeable film, the oxygen permeable film having an oxygen transmission rate (OTR) of at least 10,000 cc(STP)/m²/day/1 atm at 23° C. and 0% relative humidity (RH) as measured in accordance with ASTM D3985;
a master pouch having an interior space in which the plurality of packages are enclosed, the master pouch comprised of a film having an oxygen barrier layer such that the OTR of the film of the master pouch is less than 20 cc(STP)/m²/day/1 atm at 23° C. and 0% RH as measured in accordance with ASTM D3985; and
a modified atmosphere in the interior space of the master pouch comprising carbon dioxide and having an oxygen concentration that is less than 0.1% by volume.

52. (canceled)

53. (canceled)

54. The packaged fresh food product of claim 51, wherein the fresh food product is salmon and the salmon has a Hunter (L+b)/a value of less than 3.0 one day after being removed from cold storage.

55. The packaged fresh food product of claim 51, wherein the fresh food product is salmon and the salmon has a Hunter (L+b)/a value of less than 3.0 three days after being removed from cold storage.

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)
